(19) United States
(12) Patent Application Publication
(10) Pub. No.: US 2026/0263934 A1
(43) Pub. Date: Sep. 10, 2026

(54) Virtual Object Control Method and Apparatus, Device, Storage Medium, and Program Product

(71) Applicant: Tencent Technology (Shenzhen) Company Limited, Shenzhen (CN)

(72) Inventor: Jingjing He, Shenzhen (CN)

(21) Appl. No.: 19/661,812

(22) Filed: Apr. 29, 2026

Related U.S. Application Data
(63) Continuation of application No. PCT/CN2025/083177, filed on Mar. 18, 2025.

(30) Foreign Application Priority Data
Apr. 19, 2004 (CN) 2024104805272

(51) Int. Cl. A63F 13/56; A63F 13/533; A63F 13/837

(52) U.S. Cl. CPC A63F 13/56; A63F 13/533; A63F 13/837

(57) ABSTRACT

Aspects described herein provide a system and method for controlling virtual objects, such as characters, in a virtual environment. In a virtual scene, multiple virtual objections may be on the same team and shown on the screen at the same time. One virtual object (e.g., avatar or character) can be set to follow another, automatically moving along with that teammate. When a user gives a command through their device, another virtual object (e.g., corresponding to a teammate) may be automatically moved toward a specific location in the virtual environment. Each virtual object may have its own target location, and these locations may be different (i.e., not identical). By coordinating how virtual objects move and respond to user commands, this systems and method described herein make virtual object movements and interactions faster and easier for users.

### RELATED APPLICATION

This application is a continuation of PCT Application No. PCT/CN2025/083177, filed Mar. 18, 2025, entitled “VIRTUAL OBJECT CONTROL METHOD AND APPARATUS, DEVICE, STORAGE MEDIUM AND PROGRAM PRODUCT,” which claims priority to Chinese Patent Application No. 202410480527.2, entitled “VIRTUAL OBJECT CONTROL METHOD AND APPARATUS, DEVICE, STORAGE MEDIUM, AND PROGRAM PRODUCT” filed on Apr. 19, 2024, which is incorporated herein by reference in its entirety.

### FIELD OF THE TECHNOLOGY

This application relates to the field of virtual world technologies, and in particular, to a virtual object control method and apparatus, a device, a storage medium, and a program product.

### BACKGROUND

In an application program including a virtual scene, a plurality of virtual objects are usually set, and the plurality of virtual objects may team up or otherwise be associated with one another to enter the virtual scene. One team includes a follower object and another virtual object, and the follower object may move with the other virtual object.

### SUMMARY

Aspects of this application provide a virtual object control method and apparatus, a device, a storage medium, and a program product, to extend a mobility control manner for a virtual object in a virtual scene and improve efficiency of interaction between a user and a virtual object. The technical solutions may include:

According to one aspect, a virtual object control method is provided. The method is performed by a computer device, and the method includes:
displaying at least two virtual objects in a same team;
displaying an image in which a follower object moves with a first virtual object, the first virtual object being one of the at least two virtual objects, and the follower object being a virtual object of the at least two virtual objects other than the first virtual object; and
controlling a third virtual object to move toward a reference position in a virtual scene in response to a terminal device corresponding to a second virtual object receiving a reference operation, the second virtual object and the third virtual object each being one of the at least two virtual objects, and reference positions respectively corresponding to the at least two virtual objects being different (i.e., not the exact same).

According to another aspect, a virtual object control apparatus is provided. The apparatus includes:
a first display module, configured to display at least two virtual objects in a same team;
a second display module, configured to display an image in which a follower object moves with a first virtual object, the first virtual object being one of the at least two virtual objects, and the follower object being a virtual object of the at least two virtual objects other than the first virtual object; and
a moving module, configured to control a third virtual object to move toward a reference position in a virtual scene in response to a terminal device corresponding to a second virtual object receiving a reference operation, the second virtual object and the third virtual object each being one of the at least two virtual objects, and reference positions respectively corresponding to the at least two virtual objects being different (i.e., not the exact same).

According to still another aspect, a computer device is provided. The computer device includes a processor and a memory. The memory has at least one instruction, at least one program, a code set, or an instruction set stored therein. The at least one instruction, the at least one program, the code set, or the instruction set is loaded and executed by the processor, to enable the computer device to implement the foregoing virtual object control method.

According to yet another aspect, a nonvolatile computer-readable storage medium is provided. The nonvolatile computer-readable storage medium has at least one instruction, at least one program, a code set, or an instruction set stored therein. The at least one instruction, the at least one program, the code set, or the instruction set is loaded and executed by a processor, to enable a computer to implement the foregoing virtual object control method.

According to a further aspect, a computer program product or a computer program is provided. The computer program product or the computer program includes computer instructions. The computer instructions are stored in a nonvolatile computer-readable storage medium. A processor of a computer device reads the computer instructions from the nonvolatile computer-readable storage medium. The processor executes the computer instructions, to enable the computer device to perform the virtual object control method provided in the foregoing implementations.

When a plurality of virtual objects in a team move with one virtual object and a terminal device corresponding to a virtual object of the team receives a reference operation, virtual objects in the team may be automatically controlled to scatteredly move toward different positions in a virtual scene, without waiting for users of all virtual objects to manually control movement of their virtual objects after the virtual objects move to a same position along with the virtual object. This extends a manner of controlling movement of the virtual objects in the virtual scene, and further extends a manner of controlling, by the users, the virtual objects to interact with the virtual scene and improves efficiency of interaction between the users and the virtual objects, to improve interaction experience of the users and increase a human-computer interaction rate.

The foregoing general descriptions and the following detailed descriptions are exemplary and explanatory only and are not intended to limit this application.

### BRIEF DESCRIPTION OF THE DRAWINGS

FIG. 1 is a block diagram of a structure of an example computer system according to one or more aspects described herein.

FIG. 2 is a flowchart of an example virtual object control method according to one or more aspects described herein.

FIG. 3 is a diagram of example prompt elements according to one or more aspects described herein.

FIG. 4 is a flowchart of another example virtual object control method according to one or more aspects described herein.

FIG. 5 is a diagram of an example display of a scatter control according to one or more aspects described herein.

FIG. 6 is a flowchart of another example virtual object control method according to one or more aspects described herein.

FIG. 7 is a diagram of another example display of select controls according to one or more aspects described herein.

FIG. 8 is an example diagram of setting a reference position of a candidate object according to one or more aspects described herein.

FIG. 9 is an example diagram of a distributed display of reference positions according to one or more aspects described herein.

FIG. 10 is an example diagram of a parachute flight according to one or more aspects described herein.

FIG. 11 is an example diagram of a scattered landing button according to one or more aspects described herein.

FIG. 12 is an example diagram of scattered landing according to one or more aspects described herein.

FIG. 13 is an example diagram of a parachute flight from a teammate's perspective according to one or more aspects described herein.

FIG. 14 is an example diagram of gliding by a teammate according to one or more aspects described herein.

FIG. 15 is an example diagram of scattered landing from a teammate's perspective according to one or more aspects described herein.

FIG. 16 is an example diagram of landing according to one or more aspects described herein.

FIG. 17 is a flowchart of an example interaction between a server and a client according to one or more aspects described herein.

FIG. 18 is an example diagram of selecting a landing range according to one or more aspects described herein.

FIG. 19 is an example diagram of selecting a ground landing point according to one or more aspects described herein.

FIG. 20 is another example diagram of selecting a ground landing point according to one or more aspects described herein.

FIG. 21 is another example diagram of selecting a ground landing point according to one or more aspects described herein.

FIG. 22 is another example diagram of selecting a ground landing point according to one or more aspects described herein.

FIG. 23 is another example diagram of selecting a ground landing point according to one or more aspects described herein.

FIG. 24 is another example diagram of selecting a ground landing point according to one or more aspects described herein.

FIG. 25 is an example diagram of allocating landing trajectories according to one or more aspects described herein.

FIG. 26 is a block diagram of an example virtual object control apparatus according to one or more aspects described herein.

FIG. 27 is a diagram of a structure of an example computer device according to one or more aspects described herein.

The accompanying drawings herein are incorporated into the specification and constitute a part of the specification, show embodiments that conform to this application, and are configured for explaining the principle of this application together with the specification.

### DETAILED DESCRIPTION

Exemplary aspects are described in detail herein, and examples of the exemplary aspects are shown in the accompanying drawings. When the following description involves the accompanying drawings, unless otherwise specified, the same numerals in different accompanying drawings represent the same or similar elements. Implementations described in the following exemplary aspects do not represent all implementations that are consistent with this application. On the contrary, the implementations are merely examples of apparatuses and methods that are consistent with some aspects of this application as detailed in the appended claims.

For ease of understanding, some concepts involved in this application are explained below.

### (1) Virtual Scene

A virtual scene may refer to a virtualized scene displayed (or provided) by an application when the application is run (e.g., executed) on a terminal. The virtual scene may be a simulated environment scene of the real world, a semi-simulated and semi-fictional environment scene, or a purely fictional environment scene. The virtual scene may be any one of a two-dimensional virtual scene, a 2.5-dimensional virtual scene, or a three-dimensional virtual scene. An example in which the virtual scene is a three-dimensional virtual scene is used in the following description. However, this is not limited. In some examples, the virtual scene may also be referred to as a virtual environment, and the application may also be referred to as a client. In some arrangements, the virtual scene may be further used for a virtual scene battle between at least two virtual characters. In some arrangements, the virtual scene may be further used for a battle performed between at least two virtual characters by using virtual items. In some examples, the virtual scene may be further used for a battle performed between at least two virtual characters by using virtual items within a target region range, and the target region range becomes smaller as time passes by in the virtual scene.

The virtual scene is usually generated by an application on a terminal like a computer device and displayed based on hardware (for example, a screen) in the terminal. The terminal may be a mobile terminal like a smartphone, a tablet computer, or an ebook reader; or the terminal may be a personal computer device of a notebook computer or a stationary computer.

### (2) Virtual Object

A virtual object may refer to a movable object in a virtual scene. The movable object may be at least one of a virtual person, a virtual character, a virtual animal, or a virtual vehicle. In some examples, when the virtual scene is a three-dimensional virtual scene, the virtual object is a three-dimensional model created based on a skeletal animation technology. Each virtual object has a shape, a volume, and an orientation in the three-dimensional virtual scene, and occupies a part of space in the three-dimensional virtual scene.

### (3) Shooter Game

A shooter game may refer to a game in which a remote attack (e.g., origin of the attack is remotely located from the target of the attack) is launched by using an attack item. The shooter game may include but is not limited to a first-person shooter (FPS) game, a third-person shooter (TPS) game, and the like.

In a game, at least two virtual objects may play a single-round battle in a virtual environment. A virtual object may escape an attack launched by another virtual object and dangers (such as a poison gas circle and/or a swamp) in the virtual environment to survive in the virtual environment. When a hit point value of the virtual object in the virtual environment reaches zero, life of the virtual object in the virtual environment may end. A virtual object that survives in the virtual environment (e.g., sole survivor, survives a particular time period, etc.) is a winner. In some examples, in the battle, a moment at which the first client joins the battle may be referred to as a start moment, and a moment at which the last client exits the battle may be referred to as an end moment, and each client may control one or more virtual objects in the virtual environment. In some arrangements, an arena mode of the battle may include a single-player battle mode, a two-player group battle mode, or a multiplayer group battle mode. The battle mode is not limited to these examples. In some arrangements, the virtual object may also be referred to as a game character in a game.

### (4) User Interface (UI)

A UI may refer to an interface on which a user interacts with a computer program, a device, or an operating system. A design of the UI involves a layout, a color, an icon, a font, and the like, to ensure that the user can easily understand and operate software or the device.

### (5) Virtual Joystick

A virtual joystick may refer to an interaction control that simulates a function of a conventional physical joystick on a touchscreen mobile device (for example, a smartphone or a tablet computer). The virtual joystick is usually displayed on a game interface in a form of a circular icon or an icon in another shape, and is usually located in a lower left corner of a screen or at another position that facilitates a one-hand operation by a player. The virtual joystick includes a stationary background region (also referred to as a joystick base) and a movable control point (similar to the top of a physical joystick). The player touches and drags the control point to move in the background region, to control a moving direction and speed of a game character. An angle and a distance by which the control point deviates from a center determine the moving direction and speed of the game character. For example, when the control point is dragged to the upper right of the screen, the game character may move toward the upper right. In some arrangements, the farther the control point is from the center, the faster the virtual character might move.

In some current environments, the virtual joystick may be an important manner of movement in a mobile game. When running a game on a mobile device, a player usually needs to control a game character to move to achieve an objective in the game. A signal is received on a touchscreen mobile device through a functional component like the virtual joystick, to control the game character to move. Interaction space of the virtual joystick is controlled, through a slide operation on the screen, to deviate from its initial position, to implement movement of the game character. In some examples, the player may also be referred to as a user.

According to one or more aspects, before user-related data (for example, user account information) is collected and during collection of the user-related data, a prompt interface or a pop-up window may be displayed, or voice prompt information may be outputted. The prompt interface, the pop-up window, or the voice prompt information may be configured for notifying the user that the user-related data is currently being collected. In this way, related operations of obtaining the user-related data might only start to be performed after a confirmation operation of the user on the prompt interface or the pop-up window is obtained. Otherwise (e.g., when no confirmation operation of the user on the prompt interface or the pop-up window is obtained), the related operations of obtaining the user-related data may be ended ended, that is, obtaining of the user-related data is not performed. In other words, all user data collected in this application might only be collected with consent and authorization of the user. In addition, collection, use, and processing of the related user data need to comply with related laws, regulations, and standards of related countries and regions.

In the related art, in a following state in which a follower object moves with another virtual object, after all virtual objects in a team reach a target position, the follower object automatically releases a following relationship with the other virtual object. In this case, terminal devices of the different virtual objects may control the respective virtual objects to move separately and freely.

However, according to some aspects, when the follower object moves with the other virtual object, a moving route and an arrival position of the follower object may be consistent (e.g., the same as) with a moving route and an arrival position of the other virtual object. Users of all virtual objects need to manually control movement of their virtual objects after the virtual objects move to the same arrival position along with the virtual object. A manner of controlling movement of the virtual objects may be monotonous, affecting efficiency of interaction between the users and the virtual objects.

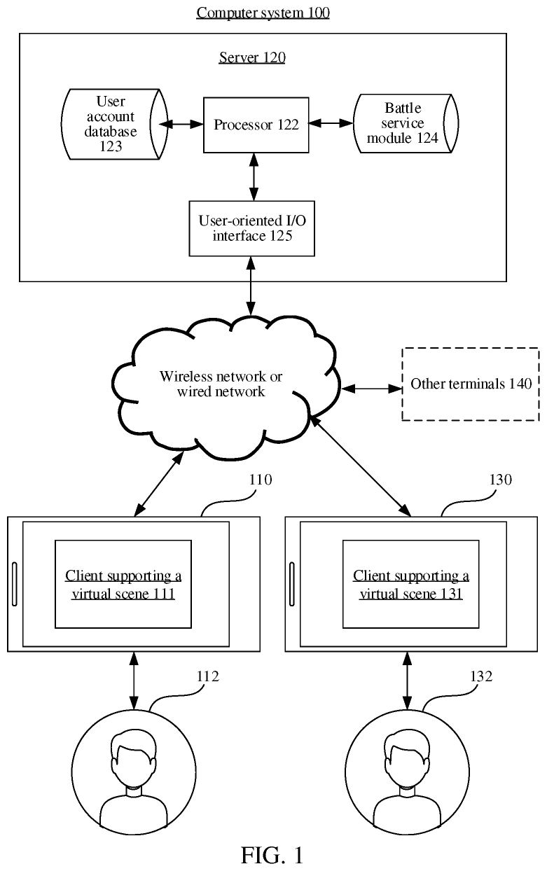

FIG. 1 is a block diagram of a structure of an example computer system according to one or more aspects described herein. The computer system 100 includes a first terminal 110, a server 120, and a second terminal 130.

A client 111 supporting a virtual scene is installed and may run or execute on the first terminal 110. The client 111 may be a multiplayer online battle program. When the first terminal 110 runs the client 111, a UI of the client 111 is displayed on a screen of the first terminal 110. The client 111 may be any one of a simulation program, a virtual reality (VR) application, an augmented reality (AR) program, a three-dimensional map program, a VR game, an AR game, a multiplayer online battle arena (MOBA) game, or a simulation game (SLG). An example in which the client 111 is a battle royale shooter game is used for the following description. The first terminal 110 is a terminal used by a first user 112. The first user 112 uses the first terminal 110 to control a first virtual object in the virtual scene to perform an activity. The first virtual object may be referred to as a virtual object of the first user 112. The activity of the first virtual object may include but is not limited to at least one of moving, jumping, teleporting, releasing a skill, using an item, adjusting a body posture, crawling, walking, running, riding, flying, driving, picking, shooting, attacking, or throwing. For example, the first virtual object is any virtual object, such as a simulated character or a cartoon character.

A client 131 supporting a virtual scene is installed and may run or execute on the second terminal 130. The client 131 may be a multiplayer online battle program. When the second terminal 130 runs the client 131, a UI of the client 131 is displayed on a screen of the second terminal 130. The client 131 may be any one of a simulation program, a battle royale shooter game, a VR application, an AR program, a three-dimensional map program, a VR game, an AR game, an FPS, a TPS, an MOBA game, or an SLG. An example in which the client 131 is a battle royale shooter game is used for the following description. The second terminal 130 is a terminal used by a second user 132. The second user 132 uses the second terminal 130 to control a second virtual object in the virtual scene to perform an activity. The second virtual object may be referred to as a virtual object of the second user 132. For example, the second virtual object may be any virtual object, such as a simulated character or a cartoon character.

In some examples, the first virtual object and the second virtual object are in a same virtual scene. Additionally or alternatively, the first virtual object and the second virtual object may belong to a same camp, a same team, or a same organization, and have a friend relationship with each other, or have temporary communication permission. According to still other aspects, the first virtual object and the second virtual object may belong to different camps, different teams, or different organizations, or have an adversarial relationship.

In some arrangements, the client installed on the first terminal 110 is the same as the client installed on the second terminal 130, or the clients installed on the two terminals are clients of a same type on different operating system platforms (Android or iOS). The first terminal 110 may be generally one of a plurality of terminals, and the second terminal 130 may be generally another one of the plurality of terminals. In the following example, only the first terminal 110 and the second terminal 130 are used for description. In some arrangements, the terminal may also be referred to as a terminal device, a user terminal device, or the like. Device types of the first terminal 110 and the second terminal 130 may be the same or different. The device type may include at least one of a smartphone, a tablet computer, an ebook reader, a moving picture experts group audio layer III (MP3) player, a moving picture experts group audio layer IV (MP4) player, a laptop portable computer, and a desktop computer.

FIG. 1 shows only two terminals as an example. However, in different scenarios, a plurality of other terminals 140 may access the server 120. In some examples, one or more terminals 140 are alternatively terminals corresponding to a developer. A development and editing platform of a client supporting a virtual scene is installed on the terminal 140. The developer may edit and update the client on the terminal 140, and transmit an updated client installation package to the server 120 through a wired or wireless network. The first terminal 110 and the second terminal 130 may download the client installation package from the server 120 to update the client.

The first terminal 110, the second terminal 130, and the other terminals 140 are connected to the server 120 through a wireless network or a wired network.

The server 120 may include at least one of one server, a plurality of servers, a cloud computing platform, and a virtualization center. The server 120 is configured to provide a background service for a client supporting a virtual scene. In some examples, the server 120 is in charge of primary computing work, and the terminal is in charge of secondary computing work (e.g., processes); or the server 120 is in charge of secondary computing work (e.g., processes), and the terminal is in charge of primary computing work; or the server 120 and the terminal perform collaborative computing by using a distributed computing architecture.

In an example, the server 120 includes a processor 122, a user account database 123, a battle service module 124, and a user-oriented input/output interface (I/O interface) 125. The processor 122 is configured to load instructions stored on the server 120, and process data in the user account database 123 and the battle service module 124. The user account database 123 is configured to store data of user accounts used on the first terminal 110, the second terminal 130, and the other terminals 140, for example, avatars of the user accounts, nicknames of the user accounts, combat effectiveness indexes of the user accounts, and service regions of the user accounts. The battle service module 124 is configured to provide a plurality of battle rooms for battles between users, for example, a 1v1 battle, a 3v3 battle, or a 5v5 battle. The user-oriented I/O interface 125 is configured to establish communication with the first terminal 110 and/or the second terminal 130 through a wireless network or a wired network to exchange data.

Methods and processes described herein may be applied to but are not limited to at least one of the following scenarios: a VR application, a three-dimensional map program, a simulation program, an MOBA game, an SLG, a multiplayer battle survival game, and the like. The following description uses an application in a game as an example.

FIG. 2 is a flowchart of an example virtual object control method according to one or more aspects described herein. The method may be performed by a computer device. The computer device may be the first terminal 110/second terminal 130 in the system shown in FIG. 1, or the computer device may be the server 120 in the system shown in FIG. 1, or the computer device may include the first terminal 110/second terminal 130 and the server 120 in the system shown in FIG. 1. The method includes the following operation 210 to operation 230.

Operation 210: Display at least two virtual objects in a same team.

In some examples, an implementation of displaying the at least two virtual objects in the same team is: displaying a scene interface of a virtual scene, the virtual scene including the at least two virtual objects in the same team. In other words, the at least two virtual objects in the same team are displayed on the scene interface of the virtual scene.

In some examples, the computer device may display the at least two virtual objects on the virtual scene interface. The virtual object may be a virtual object controlled by a user account used by a terminal to log in. The virtual scene is configured for providing a scene in which virtual tactical competition is performed between different virtual objects.

In some examples, different virtual objects may belong to different teams in the virtual scene, and each team may include at least two virtual objects. Different teams may have an adversarial relationship, an alliance relationship, or a neutral relationship. Different virtual objects in the same team have a teammate relationship, and the team may include a captain, a vice-captain, and a team member. In some arrangements, the captain, the vice-captain, and the team member may be different virtual objects.

In some examples, the virtual scene may further include a virtual building, a virtual vehicle, and a virtual item.

Operation 220: Display a picture in which a follower object moves with a first virtual object, the first virtual object being one of the at least two virtual objects, and the follower object being a virtual object of the at least two virtual objects other than the first virtual object.

The first virtual object may be a virtual object of the captain role in the team. For example, at the beginning of the virtual scene, the virtual object of the captain role in the team first parachutes, and after a user corresponding to another virtual object in the team chooses to parachute in a following manner, the other virtual object may serve as or become a follower object that parachutes with the virtual object of the captain role into the virtual scene.

Alternatively, the first virtual object may be a virtual object of a non-captain role in the team.

In some arrangements, a manner of displaying the picture (e.g., image) in which the follower object moves with the first virtual object is: displaying, on the scene interface, the picture/image in which the follower object moves with the first virtual object.

In some arrangements, the follower object may choose to follow the first virtual object, and during following, a user terminal device corresponding to the follower object displays, by default, a picture, image, or view from a perspective of the follower object. For example, a scene picture or image obtained by photographing the virtual scene by using a camera model corresponding to/matching the perspective of the follower object may be displayed. The user terminal device corresponding to the follower object is a terminal device used by a user who controls the follower object. The perspective of the follower object may be a first-person perspective of the follower object, or may be a third-person perspective of the follower object. When the perspective of the follower object is the first-person perspective of the follower object, the camera model corresponding to/matching the perspective of the follower object is usually at a head position of the follower object. When the perspective of the follower object is the third-person perspective of the follower object, the camera model corresponding to/matching the perspective of the follower object is usually kept at a specific distance and a relative positional relationship with the follower object.

Alternatively, during following, a user terminal device corresponding to the follower object may display, by default, a picture from a perspective of the first virtual object, specific.g., a scene picture obtained by photographing the virtual scene by using a camera model corresponding to/matching the perspective of the first virtual object. The perspective of the first virtual object may be a first-person perspective of the first virtual object, or may be a third-person perspective of the first virtual object. When the perspective of the first virtual object is the first-person perspective of the first virtual object, the camera model corresponding to/matching the perspective of the first virtual object is usually at a head position of the first virtual object. When the perspective of the first virtual object is the third-person perspective of the first virtual object, the camera model corresponding to/matching the perspective of the first virtual object is usually kept at a specific distance and a relative positional relationship with the first virtual object.

In an arrangement, the user who controls the follower object may switch, by triggering a control on a terminal device, a perspective currently displayed on the terminal device by default to another, e.g., third, perspective. In this case, the user terminal device of the follower object displays a picture from the third perspective. The picture from the third perspective is a scene picture or image obtained by observing the virtual scene from the third perspective. In other words, the picture from the third perspective is a scene picture obtained by photographing the virtual scene by using a camera model corresponding to/matching the third perspective. For example, the third perspective is a perspective other than the perspective of the follower object and the perspective of the first virtual object.

In some examples, a user corresponding to the first virtual object may control the first virtual object to initiate a virtual attack against another virtual object, and the user corresponding to the follower object may control the follower object to initiate a virtual attack against another virtual object.

For example, an implementation of an attack operation against the another virtual object may include but is not limited to at least one of the following: clicking/tapping, sliding, or rotating, for example, clicking/tapping a touchscreen or a button, sliding on a touchscreen or with a handle, or rotating a terminal or a handle.

For example, a manner of performing a virtual attack by the first virtual object/follower object may include but is not limited to at least one of the following: launching a virtual shooting item, throwing a virtual throwing item, waving a virtual weapon, or releasing a virtual skill. A specific implementation of performing a virtual attack by the first virtual object against the other virtual object is not limited to these examples.

In some arrangements, the first virtual object/follower object may take a virtual vehicle to reach a specific region of the virtual scene. For example, the virtual vehicle may include but is not limited to at least one of the following: an aircraft, a parachute, a paraglider, an automobile, a motorcycle, or a watercraft. In a possible implementation, the virtual vehicle may be taken by the at least two virtual objects.

In this example, in the virtual scene, when the follower object moves with the first virtual object, a moving direction, a moving route, a moving distance, and a moving mode of the follower object are consistent with a moving direction, a moving route, a moving distance, and a moving mode of the first virtual object. According to one or more aspects, the moving mode may be taking (e.g., riding or driving) a virtual vehicle, parachuting, wingsuit flying, or the like. When moving to follow the first virtual object, the follower object may take the same moving mode (e.g., riding a virtual vehicle) to follow the first virtual object.

In some arrangements, the follower object may start to follow the first virtual object when the first virtual object is in a stationary state. The stationary state may include but is not limited to: the first virtual object remaining in at least one of the following states in the virtual scene for a specified period of time: standing, squatting, lying down, or prostrating.

In some arrangements, the follower object may start to follow the first virtual object when the first virtual object is in a moving state. The moving state may include but is not limited to: the first virtual object being in at least one of the following states in the virtual scene: running, jumping, crawling, swimming, or driving.

In some examples, the user of the follower object may trigger a following operation through a reference control of the terminal device, for example, perform a click/tap, hold, or slide operation on the reference control, to control the follower object to move with the first virtual object. The reference control may be any control bound with the following operation, and the reference control may be at any position on the scene interface of the virtual scene.

In other examples, the follower object may automatically follow the first virtual object when meeting a reference condition. For example, when the follower object has a low health point and a few resources, the follower object may automatically follow a teammate with a high health point or abundant resources. In other words, the reference condition may be that a health point of the follower object is lower than a health point threshold, resources of the follower object are fewer than a resource threshold, or the like. The health point threshold and the resource threshold may be set based on experience or flexibly adjusted based on an application scenario. The reference condition is not limited to such examples.

In other examples, a server may automatically indicate or instruct the follower object to follow the first virtual object based on a task type of the virtual objects in the virtual scene. For example, the current virtual scene includes six virtual objects, and the task type is point occupying (teams of different camps preempt a same target point position). In this case, the server divides, based on a current quantity of persons, six virtual objects 1 to 6 in the virtual scene into two teams: a team A and a team B. Three different virtual objects are allocated to each team (one virtual object acts as a captain, and the other two virtual objects act as team members). In team A, a virtual object 1 acts as a captain (namely, the first virtual object), and a virtual object 2 and a virtual object 3 act as team members (namely, the follower object). In team B, a virtual object 4 acts as a captain (namely, the first virtual object), and a virtual object 5 and a virtual object 6 act as team members (namely, the follower object). Team A and team B are in an adversarial relationship. When performing a point occupying task, the virtual object 2 and the virtual object 3 may automatically move with the virtual object 1 to a target point position, and the virtual object 5 and the virtual object 6 may automatically move with the virtual object 4 to a target point position.

Operation 230: Control a third virtual object to move toward a reference position in the virtual scene in response to a terminal device corresponding to a second virtual object receiving a reference operation, the second virtual object and the third virtual object each being one of the at least two virtual objects, and reference positions respectively corresponding to the at least two virtual objects being different (i.e., not the exact same).

In some arrangements, the reference operation may be an operation triggered by a user on a control displayed on the terminal device.

The second virtual object and the first virtual object may be the same virtual object, or the second virtual object and the first virtual object may be different virtual objects.

The third virtual object may be any virtual object in the team. For example, the third virtual object may be the first virtual object or the second virtual object, or may be a virtual object in the team other than the first virtual object and the second virtual object. In some examples, the computer device performing the processes described with respect to FIG. 2 may be a terminal device corresponding to the third virtual object, to be specific, a terminal device used by a user who controls the third virtual object.

In such arrangements, the at least two virtual objects in the team have respective reference positions, and the respective reference positions of the at least two virtual objects in the team are not the same (e.g., not the same position). To be specific, after the terminal device corresponding to the second virtual object receives the reference operation, the virtual objects in the team scatteredly move to two or more positions in the virtual scene. In this way, when the virtual objects in the team move in a following manner, the virtual objects are automatically scattered to different positions in the virtual scene.

The reference position is a position to which each virtual object in the team needs to move in the virtual scene. The reference position may be automatically allocated by the computer device, or may be manually selected by a user.

In some arrangements, the reference position may be determined based on a target task type of the third virtual object in the virtual scene, a character type of the third virtual object, or another condition.

In some arrangements, the reference position may be determined based on a target task type of the third virtual object in the virtual scene. For example, when a target task of the third virtual object in the virtual scene is point occupying (e.g., occupying an objective or a location), after the terminal device corresponding to the second virtual object receives the reference operation, the computer device controls the third virtual object to move toward a task point closest to the third virtual object in the virtual scene.

In some examples, the reference position may alternatively be determined based on a character type of the third virtual object in the virtual scene. For example, when a character of the third virtual object is a sniper, after the terminal device corresponding to the second virtual object receives the reference operation, the computer device controls the third virtual object to move toward a position region including a virtual sniper rifle in the virtual scene.

In such examples, when a plurality of virtual objects in a team move with one virtual object and a terminal device corresponding to a virtual object receives a reference operation, virtual objects in the team may be automatically controlled to scatteredly move toward different positions in a virtual scene, without waiting for users of all virtual objects to manually control movement of their virtual objects after the virtual objects move to a same position along with the virtual object. This extends a manner of controlling movement of the virtual objects in the virtual scene, and further extends a manner of controlling, by the users, the virtual objects to interact with the virtual scene and improves efficiency of interaction between the users and the virtual objects, to improve interaction experience of the users and increase a human-computer interaction rate.

According to one or more aspects, a reference position may be in a sub-region in a first region, and sub-regions to which the reference positions respectively corresponding to the at least two virtual objects belong may be different from one another. The first region is a region corresponding to a position of the second virtual object.

The first region is a region in the virtual scene. The first region is a region corresponding to the position of the second virtual object. The position of the second virtual object is a position of the second virtual object in the virtual scene. For example, the region corresponding to the position of the second virtual object is a reference range region around a mapping position corresponding to the position of the second virtual object. The mapping position may be a position obtained by mapping the position of the second virtual object to a target plane. The target plane is a plane to which a final moving position of a virtual object belongs. For example, the target plane may be a ground plane in the virtual scene. The reference range region around the mapping position may be set based on experience or flexibly adjusted based on an application scenario. Setting or defining the region is not limited to such examples.

In some examples, the reference range region around the mapping position may be a circular region with the mapping position as a center and with a reference length as a radius, or may be a three-dimensional region within a reference range and with the mapping position as a center point, or may be a region within a reference range in a reference direction (east, south, west, or north) and with the mapping position as a start point.

In some examples, the first region may be selected by a user, or may be determined by the computer device.

In some examples, the first region includes at least two sub-regions, and different sub-regions have different coverage ranges in the virtual scene.

In such arrangements, the reference positions corresponding to the virtual objects in the team may be scattered in the region corresponding to the position of the second virtual object. In this way, when the virtual objects automatically and scatteredly move, the virtual objects are not scattered too far from each other, to ensure controllability of scattered positions of the virtual objects and improve movement effect of scattered movement of the virtual objects, to further improve effect of interaction between a user and the virtual scene, improve interaction experience of the user, and increase a human-computer interaction rate.

In some arrangements, the sub-regions to which the reference positions respectively corresponding to the at least two virtual objects belong are at least two sub-regions, among sub-regions of the first region, that are ranked in descending order of region priorities.

In such arrangements, each sub-region in the first region has a region priority. The region priority of the sub-region is configured for indicating a priority of selecting the current sub-region as a reference position in the first region. The region priority of the sub-region provides reference for the computer device/user to determine a reference position of a virtual object. The sub-regions to which the reference positions respectively corresponding to the at least two virtual objects belong are at least two sub-regions with highest region priorities among the sub-regions of the first region.

In some arrangements, the region priorities may be preset by a developer, or may be obtained based on an arrangement order of the sub-regions after the computer device sorts the sub-regions based on a sorting condition. The sorting condition may be set based on experience or flexibly adjusted based on an application scenario. Sorting and priority setting are not limited to such examples. In some examples, the sorting condition may be sorting in descending order of areas of the sub-regions, or sorting in ascending order of distances between the sub-regions and a center point of the first region, or sorting in descending order of quantities of virtual resources included in the sub-regions, or the like.

In one example, a first region may include three sub-regions of different types: a mountainous region, a city region, and a town. The developer presets a region priority of the mountainous region as 3, a region priority of the city region as 1, and a region priority of the town as 2 (a smaller digit indicates a higher region priority). The three sub-regions are sorted in descending order of region priorities, and a sorting result is sequentially as follows: the city region, the town, and the mountainous region. In this case, the computer device selects, by default, two sub-regions (the city region and the town) ranked in front as the sub-regions to which the reference positions respectively corresponding to the at least two virtual objects belong.

According to one or more aspects, the sub-regions to which the reference positions belong are determined based on the region priorities, so that a virtual object is more likely to move toward a more important or beneficial region, to complete a target task of a team, and a reference position for automatic movement of the virtual object in the virtual scene is more accurate. This improves effect of interaction between a user and the virtual scene, to improve interaction experience of the user and increase a human-computer interaction rate.

In some arrangements, the region priority of the sub-region is associated with at least one of the following information:
a quantity of virtual resources included in the sub-region;
a type of a virtual resource included in the sub-region; and
a region type of the sub-region.

In some examples, the virtual resource is a resource that can be used by a virtual object in the virtual scene, and the virtual resource may be a virtual item, a skill, a prop, or the like that is obtained, used, or exchanged by the virtual object in the virtual scene.

In some arrangements, the type of the virtual resource includes but is not limited to:
(1) Virtual items and virtual equipment: The virtual items and the virtual equipment, such as virtual medicines and virtual armor, may improve attributes, such as abilities, defense, and attacking, of a character corresponding to a virtual object. The virtual object may obtain the virtual items and the virtual equipment by exploring, battling, or completing a task.
(2) Skills and experience: The skills and the experience are abilities of a character of a virtual object that are to be continuously improved in a game. The virtual object may obtain experience by completing a task, battling, or performing another activity, and use the experience to improve a skill level of the character or unlock a new skill.
(3) Virtual natural resources: for example, ore, timber, or food, used by a virtual object to make an item, construct a building, or complete a task in a virtual scene. The virtual object may meet requirements in the virtual scene by collecting the resources.
(4) Special ability or permission: for example, unlocking a new map region or obtaining a special character skill.

In some examples, the region type of the sub-region includes but is not limited to:
(1) City/Urban region: The city/urban region is one of common region types in a virtual scene, and includes a street, a building, a park, a shop, and the like. A virtual object may perform exploration, perform interaction, and complete a task in the city/urban region, and interact with another virtual object.
(2) Wild/Natural region: The wild/natural region usually includes natural landscapes such as a forest, a grassland, a river, and a mountain. A virtual object may perform activities such as adventure, hunting, and resource collection in these regions.
(3) Subsurface/Cavern region: The subsurface/cavern region usually includes a maze, a cavern system, a subsurface city, or the like. A virtual object may search for virtual objects/treasures, fight against virtual monsters, explore secrets, or the like in these regions.
(4) Water/Ocean region: The water/ocean region includes water landscapes such as a lake, a river, and an ocean. A virtual object may perform activities such as sailing, fishing, and diving in the water/ocean region.
(5) Desert/Wilderness region: The desert/wilderness region usually includes landscapes such as dunes, rocks, and desert vegetation. A virtual object may challenge extreme environments, search for hidden treasure, or the like in these regions.
(6) Snowfield/Icefield region: The snowfield/icefield region usually includes landscapes such as snow mountains, glaciers, and frozen lakes. A virtual object needs to cope with challenges such as an extremely cold environment or climbing a dangerous mountain.
(7) Castle/Fortress region: The castle/fortress region is another type of region in a virtual scene, and usually includes buildings such as a city wall, a tower, and a palace. A virtual object may join a battle, guard a castle, or attack a fortress in these regions.
(8) Urban relics/ruins region: The urban relics/ruins region is a city building that has been abandoned or forgotten. A virtual object may search for cultural relics, learn of history, fight against monsters in ruins, or the like in these regions.

In some examples, each region type may be further divided into different sub-types. For example, the city/urban region may be further divided into a house, a warehouse, and the like, and the wild/natural region may be further divided into a forest, a hillside, and the like.

In some arrangements, the region priority of the sub-region is associated with the quantity of virtual resources included in the sub-region. For example, the region priority of the sub-region is positively correlated with the quantity of virtual resources included in the sub-region. To be specific, in the first region, a larger quantity of virtual resources included in a sub-region indicates a higher region priority of the sub-region. For example, the first region includes two sub-regions: a sub-region A1 and a sub-region B1, and the sub-region A1 includes more precious resources or key items needed by a task than those in the sub-region B1. In this case, the sub-region A1 is assigned a higher region priority than the sub-region B1, and during determining of a sub-region to which a reference position belongs, the sub-region A1 is preferentially determined.

In some arrangements, the region priority of the sub-region is associated with the type of the virtual resource included in the sub-region. For example, in the first region, a type of a virtual resource included in a sub-region is related to value of the virtual resource included in the sub-region. In this case, a region priority of the sub-region is positively correlated with the value of the virtual resource included in the sub-region. To be specific, higher value of a virtual resource included in a sub-region indicates a higher region priority of the sub-region. For example, the first region includes two sub-regions: a sub-region A2 and a sub-region B2, the sub-region A2 includes a plurality of different virtual items for a close combat, the sub-region B2 includes a plurality of different remote virtual items, and value of the virtual items for a close combat is lower than value of the remote virtual items. Therefore, the sub-region B2 is assigned a higher region priority than the sub-region A2, and during determining of a sub-region to which a reference position belongs, the sub-region B2 is preferentially determined.

In some examples, the region priority of the sub-region is associated with the region type of the sub-region. For example, the region priority of the sub-region is positively correlated with a matching degree corresponding to the region type of the sub-region, and the matching degree corresponding to the region type of the sub-region is a degree of matching between the region type of the sub-region and a character type/task type of a virtual object. The matching degree corresponding to the region type of the sub-region may be set based on experience or flexibly adjusted based on an application scenario. These examples are not limiting. To be specific, in a first region, a higher degree of matching between a region type of a sub-region and a character type/task type of a virtual object indicates a higher region priority of the sub-region. For example, the first region includes two sub-regions: a sub-region A3 and a sub-region B3, a region type of the sub-region A3 is a river, and a region type of the sub-region B3 is a tower. In this case, character types of all virtual objects are snipers. Because the sub-region B3 is at a commanding height and facilitates task execution by the snipers, the sub-region B3 better matches the character types of the virtual objects than the sub-region A3, and the sub-region B3 is assigned a higher region priority than the sub-region A3. During determining of a sub-region to which a reference position belongs, the sub-region B3 is preferentially determined.

In such arrangements or examples, in addition to being associated with one of the quantity of virtual resources included in the sub-region, the type of the virtual resource included in the sub-region, and the region type of the sub-region, the region priority of the sub-region may alternatively be determined based on two or more of the foregoing types of information.

For example, first sub-priorities respectively corresponding to different sub-regions are first assigned based on quantities of virtual resources included in the sub-regions, and when first sub-priorities of two or more sub-regions are the same, a region priority between the two or more sub-regions is further determined based on a type of a virtual resource included in each sub-region.

In another example, a manner of determining the region priority of the sub-region based on two or more of the foregoing types of information may alternatively be: determining one indicator corresponding to the sub-region based on each piece of information that needs to be considered; and performing summation or weighted summation on indicators determined based on all information that needs to be considered, to obtain a measuring indicator of the sub-region, the measuring indicator of the sub-region being positively correlated with the region priority of the sub-region. The information that needs to be considered may include two or three of the following information: the quantity of virtual resources included in the sub-region, the type of the virtual resource included in the sub-region, and the region type of the sub-region.

For example, an indicator determined based on the quantity of virtual resources included in the sub-region is positively correlated with the quantity of virtual resources included in the sub-region, an indicator determined based on the type of the virtual resource included in the sub-region is positively correlated with value corresponding to the type of the virtual resource included in the sub-region, and an indicator determined based on the type of the sub-region is positively correlated with the matching degree corresponding to the region type of the sub-region.

By comprehensively considering a plurality of factors, the computer device may automatically determine the region priority of the sub-region according to a requirement of the virtual scene/virtual object, to guide users to move toward different sub-regions and perform interaction, so that the virtual object is more likely to move toward a more important or beneficial region, to complete a target task of a team, and a reference position for automatic movement of the virtual object in the virtual scene is more accurate. This improves effect of interaction between the users and the virtual scene, to improve interaction experience of the users and increase a human-computer interaction rate.

In some arrangements, a position, in a region queue, of the sub-region to which the reference position corresponding to the third virtual object belongs is associated with a number of the third virtual object in the team, and the region queue is a queue of at least two sub-regions arranged in descending order of region priorities.

In such arrangements, each virtual object in the team has a number, and the numbers are unique and are configured for identifying different virtual objects in the same team. The numbers may be determined based on an order in which the virtual objects enter the virtual scene, or may be selected and allocated by a user corresponding to a captain in the team.

In some examples, the position, in the region queue, of the sub-region to which the reference position corresponding to the third virtual object belongs is determined based on the number of the third virtual object in the team. For example, a current number of the third virtual object is 2. Correspondingly, the position, in the region queue, of the sub-region to which the reference position of the third virtual object belongs is the second position. To be specific, the computer device may determine a sub-region, in the region queue, whose region priority is ranked the second as a sub-region to which a reference position corresponding to a virtual object whose number is 2 belongs.

In some arrangements, an order of sub-regions to which reference positions corresponding to virtual objects in the team belong are determined based on numbers of the virtual objects in the team. For example, when a sequence number of the third virtual object in the team is 3, the third virtual object is a virtual object, in the team, that is in a sub-region to which the third determined reference position belongs.

In such arrangements, sub-regions to which reference positions corresponding to virtual objects belong are associated with numbers in the team, to help better manage a sub-region corresponding to each virtual object, improve task completion efficiency, and guide users to move toward different sub-regions. This extends a manner of movement of the virtual objects in the virtual scene, and further extends a manner of controlling, by the users, the virtual objects to interact with the virtual scene and improves effect of interaction between the users and the virtual scene, to improve interaction experience of the users and increase a human-computer interaction rate.

In some arrangements, the sub-regions to which the reference positions respectively corresponding to the at least two virtual objects belong are at least two sub-regions, among sub-regions of the first region, that are specified by the reference operation.

In some examples, when performing the reference operation, a user corresponding to the second virtual object may specify, by using the reference operation, a sub-region to which a reference position corresponding to each virtual object in the team belongs.

According to one or more aspects, the user may specify, according to a requirement and by using the reference operation, a sub-region to which a reference position corresponding to each virtual object belongs, so that different virtual objects move to different sub-regions. This extends a manner of movement of the virtual objects in the virtual scene, further extends a manner of controlling, by the user, the virtual objects to interact with the virtual scene and improves effect of interaction between the user and the virtual scene, and also ensures controllability of the reference position corresponding to each virtual object.

In some arrangements, a prompt element is displayed, the prompt element being configured for indicating a path of the third virtual object moving toward the reference position. In some examples, the prompt element is displayed on the scene interface.

The prompt element may alternatively be configured for indicating the reference position corresponding to the third virtual object. When moving toward the reference position, the third virtual object follows a guide route of the prompt element to move. In some examples, when the third virtual object reaches the reference position, the prompt element may disappear.

According to one or more aspects, a display mode of the prompt element includes but is not limited to at least one of the following: guidance by a light beam, indication by an arrow, or a ray trace.

In some arrangements, the prompt element may provide guidance information with different brightness. Brightness of the prompt element indicates a distance between the third virtual object and the reference position. For example, when the third virtual object is closer to the reference position, the brightness of the prompt element is lower; and when the third virtual object reaches the reference position, the brightness disappears.

In other examples, the prompt element may provide guidance information in colors of different depths. A depth of a color of the prompt element indicates a distance between the third virtual object and the reference position. For example, when the third virtual object is closer to the reference position, the color of the prompt element is deeper; and when the third virtual object reaches the reference position, the color disappears.

According to one or more aspects, the prompt element is displayed on the terminal device to explicitly indicate a path of a virtual object moving toward a reference position, to guide the virtual object to move toward the reference position. This improves effect of interaction between a user and the virtual scene, to improve interaction experience of the user and increase a human-computer interaction rate.

In some arrangements, a number of a fourth virtual object in the team is displayed based on a reference position corresponding to the fourth virtual object. The fourth virtual object is a virtual object in the team other than the third virtual object.

For example, an implementation of displaying the number of the fourth virtual object in the team based on the reference position corresponding to the fourth virtual object may be: displaying, at the reference position corresponding to the fourth virtual object, the number of the fourth virtual object in the team.

In another example, an implementation of displaying the number of the fourth virtual object in the team based on the reference position corresponding to the fourth virtual object may alternatively be: displaying, in a sub-region including the reference position corresponding to the fourth virtual object, the number of the fourth virtual object in the team.

In still another example, an implementation of displaying the number of the fourth virtual object in the team based on the reference position corresponding to the fourth virtual object may alternatively be: displaying, in a surrounding region (for example, an upper region, a lower region, a region on the left, or a region on the right) of the reference position corresponding to the fourth virtual object, the number of the fourth virtual object in the team.

According to such aspects, when the third virtual object moves toward the reference position, a number of another virtual object in the team may be displayed in the virtual scene. For example, the number of the another virtual object in the team is displayed in a sub-region of the first region, to indicate that a position in the current sub-region is a reference position of a virtual object corresponding to the number.

In some arrangements, when the fourth virtual object reaches the reference position corresponding to the fourth virtual object, number information might not be displayed.

In some examples, a number of the third virtual object in the team and indication information are displayed based on the reference position corresponding to the third virtual object. In some arrangements, the indication information is configured for indicating at least one of the following: a range of a sub-region including the reference position corresponding to the third virtual object, and a distance between the third virtual object and the reference position corresponding to the third virtual object.

For example, an implementation of displaying the number of the third virtual object in the team and the indication information based on the reference position corresponding to the third virtual object may be: displaying, at the reference position corresponding to the third virtual object, the number of the third virtual object in the team and the indication information.

In other examples, an implementation of displaying the number of the third virtual object in the team and the indication information based on the reference position corresponding to the third virtual object, may alternatively be: displaying, in a sub-region including the reference position corresponding to the third virtual object, the number of the third virtual object in the team and the indication information.

In still other examples, an implementation of displaying the number of the third virtual object in the team and the indication information based on the reference position corresponding to the third virtual object, may alternatively be: displaying, in a surrounding region (for example, an upper region, a lower region, a region on the left, or a region on the right) of the reference position corresponding to the third virtual object, the number of the third virtual object in the team and the indication information.

When the indication information is configured for indicating the range of the sub-region including the reference position corresponding to the third virtual object, the indication information includes range information of the reference position corresponding to the third virtual object. The range information may indicate a size of the range of the sub-region including the reference position corresponding to the third virtual object. The size may be a size of a range covered by a pattern formed by using a point in the sub-region to which the reference position corresponding to the third virtual object belongs as a center point and using a reference distance as a radius.

When the indication information is configured for indicating the distance between the third virtual object and the reference position corresponding to the third virtual object, the indication information includes information about a current distance between the third virtual object and the reference position. For example, the distance information is displayed in a form of a number, and indicates the current distance between the third virtual object and the reference position corresponding to the third virtual object.

In some arrangements, when the third virtual object moves toward the reference position, the number of the third virtual object in the team and the indication information are displayed at the reference position corresponding to the third virtual object; and after the third virtual object reaches the reference position, the number and the indication information at the reference position are not (or are no longer) displayed.

In some arrangements, when the third virtual object moves toward the reference position, the indication information may change with a moving progress of the third virtual object. For example, when the third virtual object is closer to the reference position corresponding to the third virtual object, a color of the number and the indication information at the reference position is lighter; and when the third virtual object reaches the reference position, the number and the indication information at the reference position disappear. In another example, when the third virtual object is closer to the reference position corresponding to the third virtual object, a number displayed in the indication information at the reference position is smaller; and when the third virtual object reaches the reference position, the indication information is displayed as 0 and then disappears.

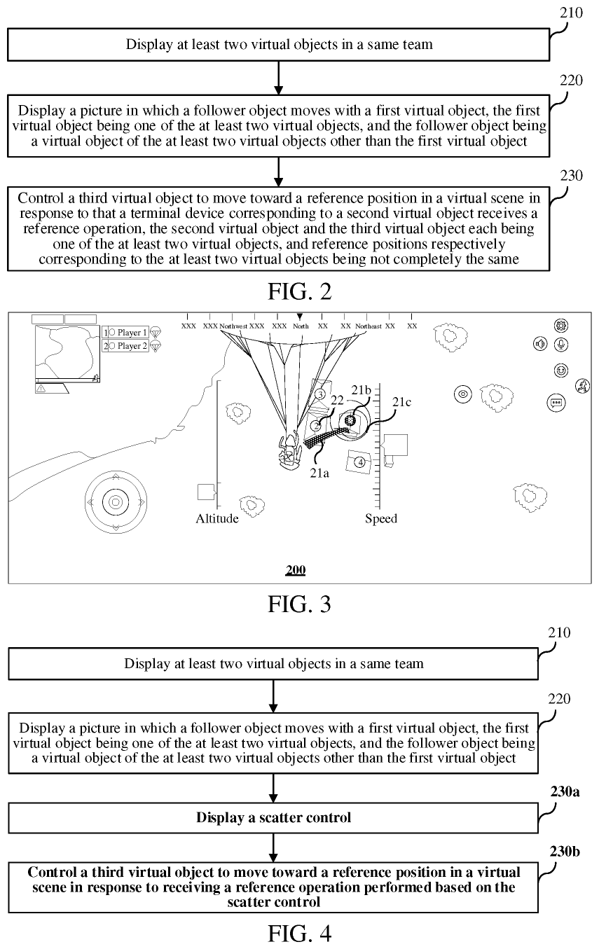

For example, FIG. 3 is a diagram of example prompt elements according to one or more aspects described herein. The prompt elements (21a, 21b, and 21c) are displayed on a scene interface 200. The prompt element 21a is displayed in a form of an arrow, and is configured for indicating the path of the third virtual object moving toward the reference position. The prompt element 21b is displayed in a highlighted form, and is configured for indicating the reference position corresponding to the third virtual object. The prompt element 21c is displayed in a form of a ring, and is configured for indicating the range of the reference position corresponding to the third virtual object. The number 22 of the fourth virtual object in the team is displayed based on the reference position corresponding to the fourth virtual object. The fourth virtual object is a virtual object in the team other than the third virtual object.

In some arrangements, when the fourth virtual object and the third virtual object are teammates of a same team, displaying the number of the fourth virtual object in the team at the reference position corresponding to the fourth virtual object can enable the third virtual object to learn of a reference position of another virtual object more quickly and intuitively, to improve effect of interaction between a user and the virtual scene, and further improve interaction experience of the user and increase a human-computer interaction rate.

In some examples, in response to that the second virtual object and the third virtual object are a same virtual object, the computer device may implement operation 230 in FIG. 2 as operation 230a and operation 230b in FIG. 4. FIG. 4 is a flowchart of an example virtual object control method according to one or more aspects described herein. The method includes the following operations:

Operation 230a: Display a scatter control.

In some arrangements, the scatter control is displayed on the scene interface.

The scatter control is configured for releasing (e.g., cancelling) a following relationship between the follower object and the first virtual object on the virtual scene interface, the first virtual object being a followed object.

In this arrangement, the scatter control may be displayed in any region on the scene interface. A user may trigger the scatter control to release the following relationship between the follower object and the first virtual object, and trigger virtual objects to automatically move toward different reference positions.

In some examples, when the third virtual object meets a control display condition, the scatter control may be displayed on the scene interface. For example, among the virtual objects in the team, the follower object follows the first virtual object to descend to the ground (for example, parachute) after departing from an air vehicle in the virtual scene, and the control display condition may include: A height of the third virtual object above the ground is within a reference height range, a height of the first virtual object above the ground is within a reference height range, a minimum height/average height of each virtual object in the team above the ground is within a reference height range, or the like. The reference height range may be set based on experience or flexibly adjusted based on an application scenario. These examples are not limiting.

Alternatively, the control display condition may include another condition, for example, a quantity of resources in the first region is greater than a reference quantity threshold, or a distance between the first virtual object and a candidate position in the virtual scene is less than a reference distance threshold. The control display condition is not limited to the examples described herein. The candidate position may be any position in the virtual scene. The reference quantity threshold and the reference distance threshold may be set based on experience or flexibly adjusted based on an application scenario. Again, this example is not limiting.

Operation 230b: Control the third virtual object to move toward a reference position in the virtual scene in response to receiving a reference operation performed based on the scatter control.

In some arrangements, the reference operation may be a trigger operation of a user corresponding to the third virtual object on the scatter control, and a trigger mode includes but is not limited to at least one of the following: click/tap, hold, slide, and double-click/tap.

In some examples, the computer device (the terminal device corresponding to the third virtual object) receives the trigger operation of the user of the third virtual object on the scatter control, the computer device may automatically allocate reference positions to virtual objects (including the third virtual object), or allocate reference positions to virtual objects based on an indication of the reference operation, and terminal devices corresponding to the virtual objects control respective virtual objects to move toward the reference positions corresponding to the virtual objects.

In other arrangements, the computer device may alternatively actively trigger the scatter control when a scatter condition is met. The scatter condition may be that duration in which the follower object follows the first virtual object reaches a duration threshold. The duration threshold may be set based on experience or flexibly adjusted based on an application scenario. A scatter condition is not limited to such examples. For example, when the duration in which the follower object follows the first virtual object reaches 8 seconds, the computer device automatically triggers the scatter control, to release the following relationship between the follower object and the first virtual object, and allocate reference positions to virtual objects.

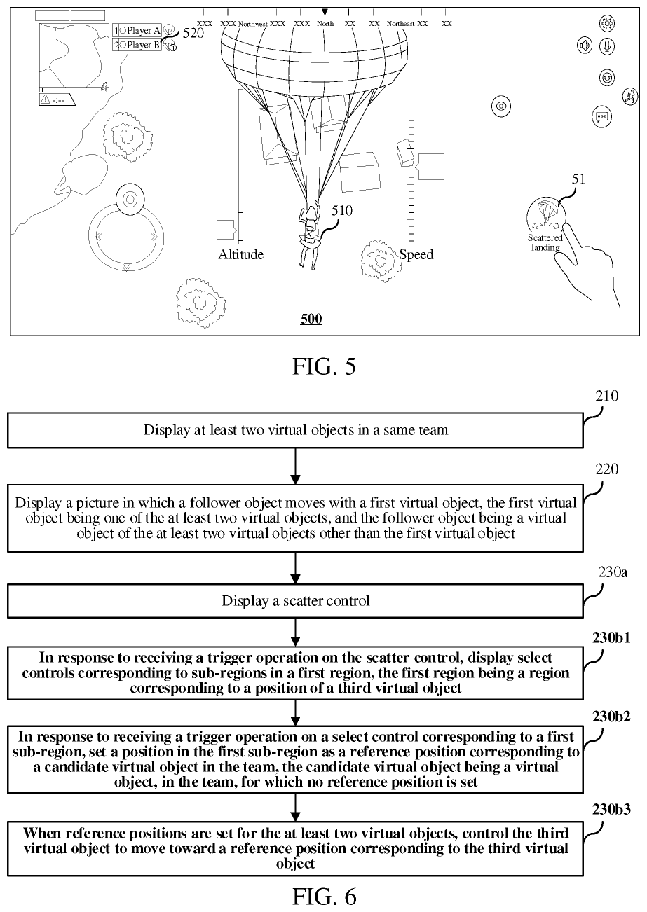

For example, FIG. 5 is a diagram of an example display of a scatter control according to one or more aspects described herein. A player A 510 (namely, the first virtual object) and a Scattered landing control 51 (namely, the scatter control) are displayed on a scene interface 500. A parachute icon on the right of a player B 520 (namely, the follower object) indicates that the player B 520 follows the player A 510. A user corresponding to the player A 510 may click/tap the Scattered landing control 51 to release a following relationship between the player B 520 and the player A 510. In response to receiving a click/tap operation performed on the scatter control, the computer device controls the third virtual object (in this example, the third virtual object, the second virtual object, and the first virtual object are the same virtual object) to move toward a reference position in the virtual scene. Correspondingly, terminal devices of other virtual objects also respectively control their own virtual objects to move toward corresponding reference positions.

In this example, when the second virtual object and the third virtual object are the same virtual object, a scatter control is displayed on the terminal device of the third virtual object, the user corresponding to the third virtual object may click/tap the scatter control to release a following relationship between different virtual objects in the same team, and the computer device automatically allocates a reference position to each virtual object, to enable different virtual objects to move toward different reference positions. This extends a manner of movement of the virtual objects in the virtual scene, and further extends a manner of controlling, by the user, the virtual objects to interact with the virtual scene and improves effect of interaction between the user and the virtual scene, to improve interaction experience of the user and increase a human-computer interaction rate.

In some arrangements, when the second virtual object and the third virtual object are the same virtual object and the reference positions of the virtual objects are positions indicated by the reference operation, operation 230b in FIG. 4 may be implemented as operations 230b1, 230b2, and 230b3 in FIG. 6. FIG. 6 is a flowchart of an example virtual object control method according to one or more aspects described herein. The method includes the following operations:

Operation 230b1: In response to receiving a trigger operation on the scatter control, display select controls corresponding to sub-regions in a first region, the first region being a region corresponding to a position of the third virtual object.

In this example, when the second virtual object and the third virtual object are a same virtual object, in response to receiving a trigger operation of a user of the third virtual object on the scatter control, the computer device may simultaneously display select controls respectively corresponding to a plurality of sub-regions. Each sub-region has a corresponding select control. The select control may be displayed in a form of a pattern or text at a center position of the sub-region or at a position around the sub-region (for example, above the sub-region).

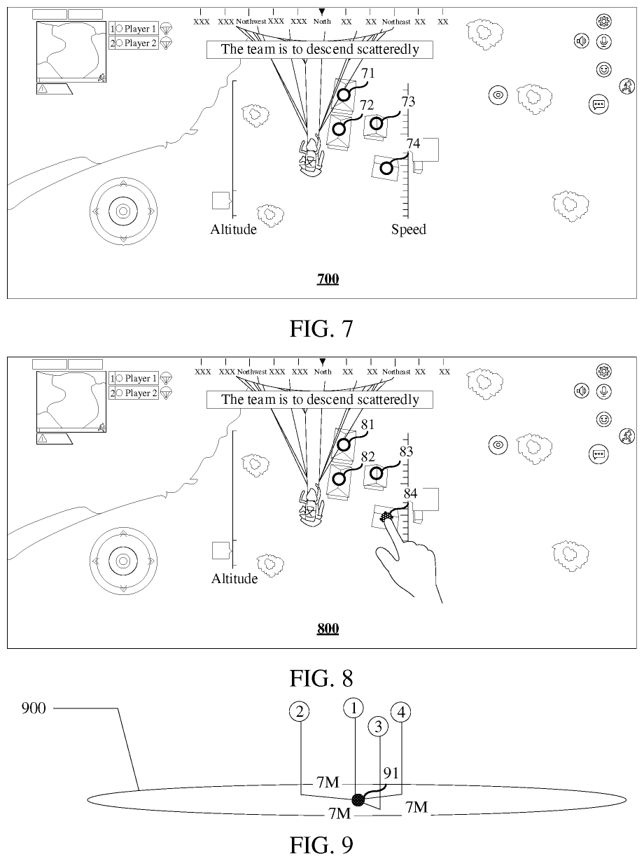

For example, FIG. 7 is a diagram of an example display of select controls according to one or more aspects described herein. In response to receiving the trigger operation on the scatter control, the computer device displays, on a scene interface 700, select controls (a control 71, a control 72, a control 73, and a control 74) respectively corresponding to four different sub-regions of a building type. The four controls are displayed in a form of circles at center positions above the sub-regions.

Operation 230b2: In response to receiving a trigger operation on a select control corresponding to a first sub-region, set a position in the first sub-region as a reference position corresponding to a candidate virtual object in the team, the candidate virtual object being a virtual object, in the team, for which no reference position is set.

In this example, a reference position of the candidate virtual object in the team may be set by using the select control by a user who performs the reference operation, or may be set by using the select control by a user corresponding to the candidate virtual object, or may be set by the computer device by actively triggering the select control when a condition is met.

In some arrangements, in response to receiving the trigger operation on the select control corresponding to the first sub-region, select controls corresponding to sub-regions are displayed on the scene interface of the terminal device corresponding to the third virtual object. The user of the terminal device corresponding to the third virtual object may sequentially perform selection operations on the select controls of the sub-regions, to sequentially set the sub-regions as sub-regions to which reference positions corresponding to virtual objects belong.

For example, the user of the terminal device corresponding to the third virtual object first clicks/taps a select control of a sub-region 1 to allocate the sub-region 1 as a sub-region to which a reference position corresponding to a virtual object in the team belongs, then the user of the terminal device corresponding to the third virtual object clicks/taps a select control of a sub-region 2 to allocate the sub-region 2 as a sub-region to which a reference position corresponding to another virtual object in the team belongs, and so on, until all virtual objects in the team are configured with sub-regions to which corresponding reference positions belong.

In some examples, each sub-region may be allocated to one virtual object. To be specific, a select control of each sub-region is allowed to be triggered once.

In other examples, each sub-region may be allocated to a plurality of virtual objects. To be specific, a select control of each sub-region is allowed to be triggered a plurality of times. When a sub-region is allocated to a plurality of virtual objects, reference positions respectively corresponding to the plurality of virtual objects may be a same position in the sub-region, for example, a center position of the sub-region. Alternatively, when a sub-region is allocated to a plurality of virtual objects, reference positions respectively corresponding to the plurality of virtual objects may be different positions in the sub-region. For example, the sub-region is a building, the building has a plurality of entrances, and the reference positions respectively corresponding to the plurality of virtual objects may be positions corresponding to different entrances in the sub-region.

In some examples, when the computer device sets, in response to receiving the trigger operation on the select control corresponding to the first sub-region, a position in the first sub-region as a reference position corresponding to the candidate virtual object in the team, the triggered select control disappears (to be specific, a select control of each sub-region is allowed to be triggered once), or a selected special effect is displayed. The selected special effect may include, but is not limited to, at least one of the following: different colors, shadows, or patterns.

For example, FIG. 8 is an example diagram of setting a reference position of a candidate object according to one or more aspects described herein. In response to receiving the trigger operation on the scatter control, the terminal device displays, on a scene interface 800, select controls (a control 81, a control 82, a control 83, and a control 84) respectively corresponding to four different sub-regions of a building type. The four controls are displayed in the form of circles at center positions above the sub-regions. In response to receiving a trigger operation of the user corresponding to the third virtual object on the select control 84 corresponding to the first sub-region, the computer device sets a position in the first sub-region as a reference position corresponding to the candidate virtual object in the team.

In other examples, in response to the scatter control being triggered, no select control is displayed on the scene interface. Users corresponding to different third virtual objects may click/tap any position in a corresponding first region on the scene interface, and a region around the clicked/tapped position may be determined as a sub-region to which the reference position corresponding to the candidate virtual object belongs. In some arrangements, a mark may be displayed in the sub-region, to indicate that the current sub-region is selected as the sub-region to which the reference position of the candidate virtual object belongs.

Operation 230b3: When reference positions are set for the at least two virtual objects, control the third virtual object to move toward the reference position corresponding to the third virtual object.

In some arrangements, on the scene interface, when all virtual objects in a same team are configured with reference positions corresponding to the virtual objects, terminal devices corresponding to the virtual objects (including the third virtual object) may automatically control respective virtual objects to move toward the reference positions corresponding to the virtual objects. Alternatively, a server of the virtual scene may automatically control the virtual objects to move toward the reference positions corresponding to the virtual objects.

In this arrangement, the user of the third virtual object may autonomously and sequentially select, by using the select controls displayed on the terminal device, the sub-regions to which the reference positions corresponding to the virtual objects in the team belong, to extend a manner of controlling, by the user, the virtual objects to interact with the virtual scene, improve effect of interaction between the user and the virtual scene, and further improve interaction experience of the user and increase a human-computer interaction rate.

In some examples, the candidate virtual object is a virtual object, in the team, for which no reference position is set and that has a smallest number in the team.

In various examples, each time a reference position of a virtual object is set, a currently selected sub-region is allocated by default to a virtual object, in the team, to which no sub-region is allocated and that has a smallest number. To be specific, a sub-region to which a reference position of each virtual object belongs is sequentially allocated in ascending order of numbers of the virtual objects in the team.

According to one or more aspects, based on a number of a virtual object, in the team, for which no reference position is set, a reference position is allocated to the virtual object, so that a clear priority is created for allocating the reference position of the candidate virtual object in the team. This helps simplify a decision-making process, improves experience of interaction between a user and the virtual scene, and further increases a human-computer interaction rate.

In some arrangements, the select control corresponding to the first sub-region is canceled after a position in the first sub-region is set as a reference position corresponding to the candidate virtual object in the team.

Additionally or alternatively, after the computer device/user sets a position in the first sub-region as a reference position corresponding to the candidate virtual object in the team, the terminal device cancels displaying the select control corresponding to the first sub-region.

In other arrangements, after the computer device/user sets a position in the first sub-region as a reference position corresponding to the candidate virtual object in the team, the select control is displayed with reference effect (for example, a tick or check is displayed on the select control, or a shadow is displayed on the select control), to indicate that the current select control can no longer be selected by another virtual object.

According to some aspects, after setting a reference position corresponding to a virtual object, the computer device/user cancels the select control corresponding to the first sub-region, to effectively notify the user of the currently selected sub-region, to avoid subsequent misoperation by the user, improve user experience, improve game experience of the user, improve effect of interaction between the user and the virtual scene, and further increase a human-computer interaction rate.

In some examples, when no virtual resource exists in the first region, reference positions corresponding to virtual objects in the team other than the second virtual object are distributed around a reference position corresponding to the second virtual object, and distances between the reference positions corresponding to the other virtual objects and the reference position corresponding to the second virtual object are reference distances.

For example, FIG. 9 is an example diagram of a distributed display of reference positions according to one or more aspects described herein. FIG. 9 shows a first region 900 and a reference position 91 corresponding to the second virtual object. When no virtual resource exists in the first region 900, reference positions corresponding to other virtual objects in the team are numbered 1 to 4. As shown in FIG. 9, the reference positions corresponding to the other virtual objects are separately distributed at positions with the reference position 91 corresponding to the second virtual object as a center and at a reference distance of 7 meters (m).

According to one or more aspects, when no virtual resource exists in the first region, the reference positions of the virtual objects other than the second virtual object are distributed around the reference position of the second virtual object, to prevent positions of a plurality of virtual objects from being excessively spaced apart after being scattered, and ensure controllability of the positions of the virtual objects after being scattered. This effectively improves experience of interaction between a user and the virtual scene, to improve effect of interaction between the user and the virtual scene and increase a human-computer interaction rate.

Based on the aspects described with respect to and shown in FIG. 2, FIG. 4, and FIG. 6, an example in which the virtual scene is a battle arena game is described below.

Aspects described herein provide a system and process in which a captain (namely, the foregoing first virtual object) can perform a scattered landing operation. After the captain clicks/taps Scattered landing, different regions may be automatically allocated to team members (namely, the foregoing follower object) for descending, to improve efficiency of material searching at the beginning. The team is a team to which the captain and the team members belong.

In a parachuting phase of the battle arena game, during team parachuting, the team members parachute by following the captain, and a perspective of the captain is as follows:
(1) Parachute flight: An aircraft enters a parachuting region, the captain clicks/taps Parachute, a teammate parachutes by following the captain, and a relative distance between the teammate and the captain is fixed at 7 m. The relative distance between the teammate and the captain is a distance between a position of the teammate in the virtual scene and a position of the captain in the virtual scene. The position of the teammate in the virtual scene may be a position of any part of the teammate in the virtual scene. The position of the captain in the virtual scene may be a position of any part of the captain in the virtual scene. For example, the virtual scene is a three-dimensional virtual scene, and the position may be represented by three-dimensional coordinates.

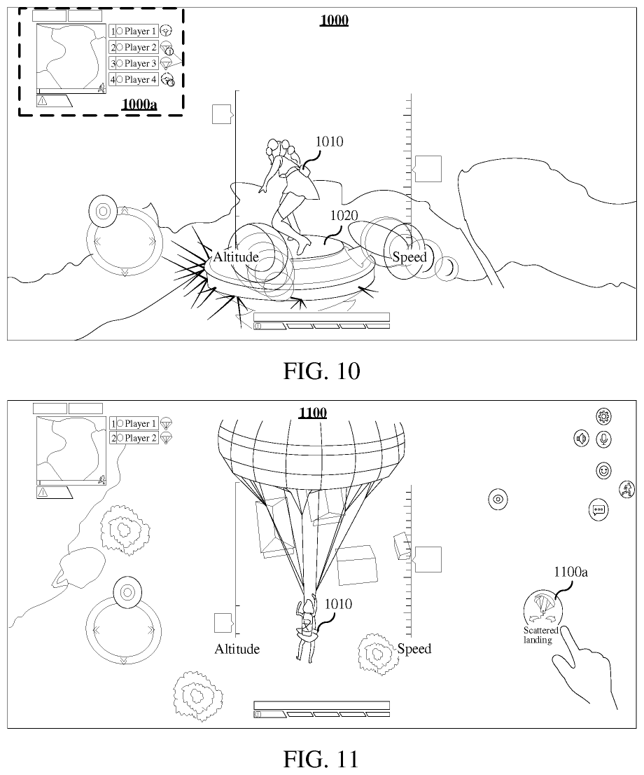

FIG. 10 is an example diagram of a parachute flight according to one or more aspects described herein.

A captain 1010 and a carrier aircraft 1020 are displayed on a parachute interface 1000 in a virtual scene, and the captain 1010 is in a ready-to-parachute state. A player 1 (a player who controls the current captain 1010) is displayed in a left region 1000a, and there are three other players (a player 2, a player 3, and a player 4). Based on identification information displayed in the left region 1000a, the player 2 chooses to parachute by following the player 1, and the player 4 chooses to parachute by following the player 3. A virtual object controlled by the player 2 and a virtual object controlled by the player 1 are on one team. In the team, the virtual object controlled by the player 1 is a captain, and the virtual object controlled by the player 2 is a teammate. A virtual object controlled by the player 3 and a virtual object controlled by the player 4 are in another team. In the team, the virtual object controlled by the player 3 is a captain, and the virtual object controlled by the player 4 is a teammate.
(2) Parachute deployment and glide: FIG. 11 is an example diagram of a Scattered landing button according to one or more aspects described herein.

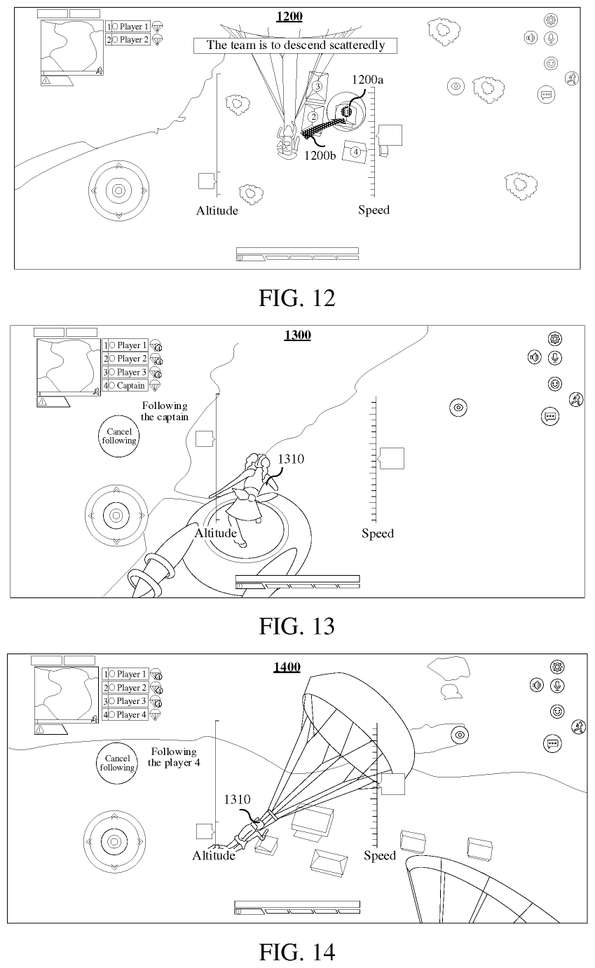

On a scene interface 1100, after gliding in the air to a height of 300 m, the captain 1010 automatically deploys a parachute and continues to glide in the air. In this case, a relative fixed distance between the captain 1010 and a team member is still 7 m. The team member moves with the captain 1010. In this case, a “Scattered landing” button 1100a appears on an interface of the captain 1010. The operation button is displayed on the interface within an altitude range of 300 m to 150 m, the button is hidden beyond (or outside) the altitude range, and the button is not displayed when nobody follows the captain 1010.
(3) Scattered landing: FIG. 12 is an example diagram of scattered landing according to one or more aspects described herein.

After the captain clicks/taps “Scattered landing”, a prompt is displayed on a scene interface 1200:“The team is to descend scatteredly”; and a three-dimensional UI of a number of a corresponding teammate is displayed at coordinates of a ground landing point. A number 1200a of the captain is highlighted and starts to blink, and a three-dimensional arrow special-effect 1200b of a connection line from the captain to the ground coordinates is generated, to imply a landing trajectory of the captain.
(4) Landing process: During scattered landing of the captain, a fixed positional relationship between the team member and the captain is released, and a flight trajectory of the captain is one that descends from current coordinates to the ground coordinates at a constant speed based on a trajectory connection line, until the captain lands on the ground. During this process, the captain may rotate a perspective without flying out of the trajectory. However, if the captain moves a direction joystick, it is determined that the captain is in a free flight, a prompt “The free descending mode is enabled” is displayed, and all UIs of scattered landing points are hidden. After virtual objects controlled by players arrive at the ground, all UIs of scattered landing are hidden.

In a parachuting phase of the battle arena game, during team parachuting, the team members parachute by following the captain, and a perspective of a team member is as follows:
(1) Parachute flight: An aircraft enters a parachuting region, the captain clicks/taps Parachute, a teammate parachutes by following the captain, and a relative distance between the teammate and the captain character is fixed at 7 m.

FIG. 13 is an example diagram of a parachute flight from a teammate's perspective according to one or more aspects described herein.

On a scene interface 1300, a teammate 1310 is ready to parachute by following the captain.
(2) Parachute deployment and glide: After parachute deployment, the teammate still glides in the air by following the captain, and the teammate and the captain move at a fixed position distance.

FIG. 14 is an example diagram of gliding by a teammate according to one or more aspects described herein.

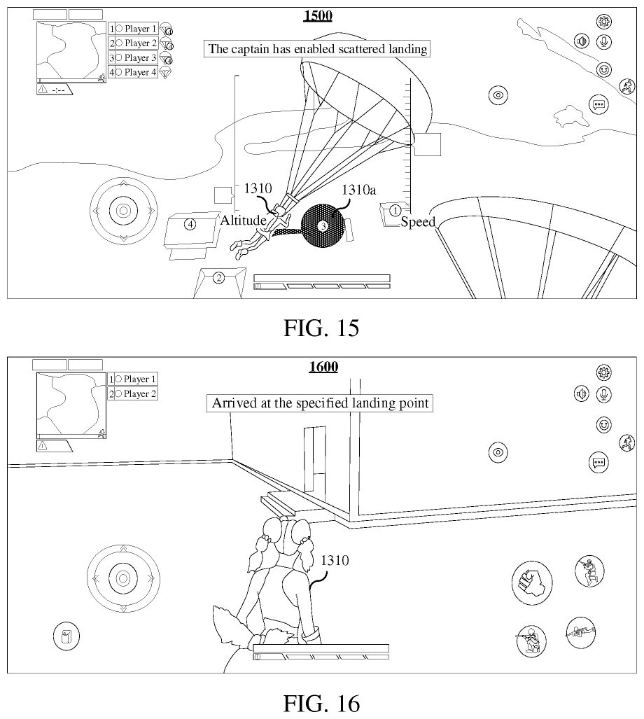

On a scene interface 1400, a teammate 1310 deploys a parachute and glides by following the captain.
(3) Scattered landing: FIG. 15 is an example diagram of scattered landing from a teammate's perspective according to one or more aspects described herein.

On a scene interface 1500, after the teammate 1310 glides in the air to a height range of 300 m and the captain performs an operation on “Scattered landing”, a prompt “The captain has enabled scattered landing” is displayed on an interface of the teammate 1310. The teammate 1310 can see coordinates of a ground landing point: a three-dimensional UI 1310a on which a number of the teammate is displayed. A UI representing the number of the teammate is highlighted and blinks, and a three-dimensional arrow special-effect of a connection line from a model of the teammate to the ground coordinates is generated, to imply a landing trajectory of the team member. In this case, by default, the teammate stops following the captain, and a “Cancel following” button is hidden or otherwise not displayed.
(4) Landing process: After the captain performs the operation on “Scattered landing”, a following relationship between the teammate and the captain is released, and the teammate descends at a constant speed based on an allocated landing trajectory. FIG. 16 is an example diagram of landing according to one or more aspects described herein. On an interface 1600, after the teammate 1310 lands, a prompt is displayed: “Arrived at the specified landing point”. In this case, if the teammate clicks/taps Cancel following, it is determined that the teammate is in free flight, and both a ground coordinate UI and a flight trajectory in the scene are hidden or otherwise not displayed.

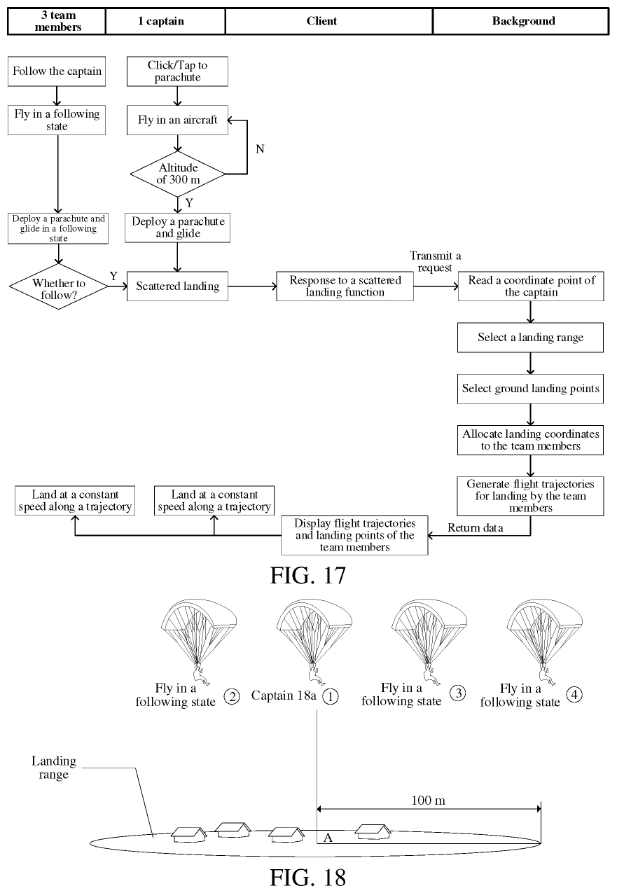

After the captain performs the operation on “Scattered landing”, a client requests an operation from a server. Processing content of the background server includes a four-step process: selecting a landing range, selecting a ground landing point, allocating a coordinate point to a team member, and allocating a landing trajectory. After completing the process, the server returns data to the client. FIG. 17 is a flowchart of an example interaction between a server and a client according to one or more aspects described herein.

Landing range selection rule (as shown in FIG. 18): FIG. 18 is an example diagram of selecting a landing range according to one or more aspects described herein.

When a captain 18a reaches an altitude of 300 m to 150 m, the captain 18a is allowed to perform a “Scattered landing” function. After the captain 18a clicks/taps the button, a request is transmitted from a client of the captain 18a to the server. The background server reads current coordinates of the captain 18a. For example, the current coordinates of the captain 18a are (20, 20, 280). In this case, a ground coordinate point A vertically marked from the coordinates of the captain 18a to the ground is (20, 20, 0). Then, a ground range with the point A as a center of a circle and with a radius of 100 m is defined as a current landing range of the team. For example, the current landing range of the team may be expressed as (20, 20, 0-120, 120, 0).

Ground landing point selection rule:

A database of the server records coordinate points of all buildings in a map, quantities of materials in the buildings, and material points and a quantity of materials outdoors. For example, coordinates of a current point A are (20, 20, 0). Therefore, the server selects coordinate points of buildings within a radius of 100 m of the point A. In this case, three teammates parachute by following one captain, and therefore four landing points are needed. Cases are as follows:

Case 1 (as shown in FIG. 19): FIG. 19 is an example diagram of selecting a ground landing point according to one or more aspects described herein.

There are four or more buildings within the landing range. The background server selects a landing point 1, a landing point 2, a landing point 3, and a landing point 4 based on a priority of a larger quantity of materials>a priority of a smaller quantity of materials and a priority of being closer to the point A>a priority of being farther away from the point A.

For example, a manner of selecting, by the background server, the landing point 1, the landing point 2, the landing point 3, and the landing point 4 based on the priority of a larger quantity of materials>the priority of a smaller quantity of materials and the priority of being closer to the point A>the priority of being farther away from the point A may be: for any building within the landing range, determining, based on a quantity of materials in the building, a first indicator corresponding to the building, the first indicator being positively correlated with the quantity of materials in the building; determining, based on a distance between the building and the point A, a second indicator corresponding to the building, the second indicator being negatively correlated with the distance between the building and the point A; determining, based on the first indicator and the second indicator, a measuring indicator corresponding to the building; and sorting all buildings in descending order of measuring indicators, and sequentially using the four top-ranked buildings as the landing point 1, the landing point 2, the landing point 3, and the landing point 4.

For example, a manner of determining, based on the first indicator and the second indicator, the measuring indicator corresponding to the building may be: using a sum of the first indicator and the second indicator as the measuring indicator corresponding to the building.

For example, a manner of determining, based on the first indicator and the second indicator, the measuring indicator corresponding to the building may alternatively be: using a sum of a first product and a second product as the measuring indicator corresponding to the building, the first product being a product of the first indicator and a first coefficient, and the second product being a product of the second indicator and a second coefficient. Both the first coefficient and the second coefficient are positive numbers. The first coefficient and the second coefficient may be set based on experience or flexibly adjusted based on an application scenario. These examples are not limiting. In some arrangements, a sum of the first coefficient and the second coefficient is 1. In other arrangements, a sum of the first coefficient and the second coefficient is not 1.

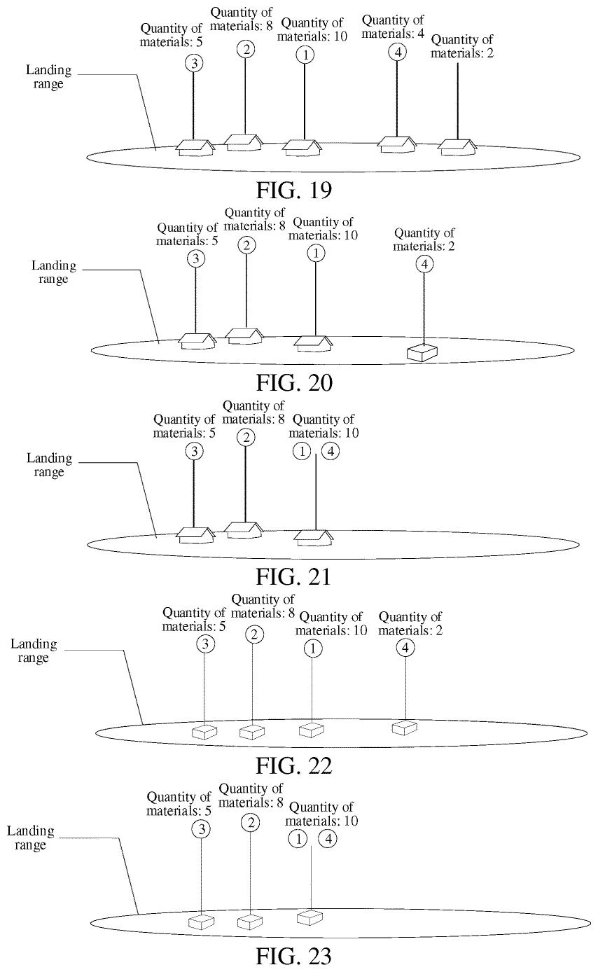

Case 2 (as shown in FIG. 20): FIG. 20 is an example diagram of selecting a ground landing point according to one or more aspects described herein.

There are more than zero and fewer than four buildings within the landing range. Assuming that there are three buildings within the range, the buildings are marked as a landing point 1, a landing point 2, and a landing point 3 based on quantities of materials in the buildings. A quantity of materials at the landing point 1 is greater than a quantity of materials at the landing point 2, and the quantity of materials at the landing point 2 is greater than a quantity of materials at the landing point 3. Then, material points outside the buildings within the range are searched for. If material points are found, a point with the largest quantity of materials is selected as a landing point 4. If no material point is found, a landing point is combined with the landing point 1 (a building with the largest quantity of materials) (spaced apart by 7 m on an x-axis). To be specific, a landing point 1+4, a landing point 2, and a landing point 3 are generated (as shown in FIG. 21).

Case 3 (as shown in FIG. 22 to FIG. 24): FIG. 22 to FIG. 24 are example diagrams of selecting a ground landing point according to one or more aspects described herein.

There is no building within the landing range. First, whether there is a material point within the range is determined.

FIG. 22 is an example diagram of selecting a ground landing point according to one or more aspects described herein, assuming that there are four material points. The four material points are sorted based on a priority of a larger quantity of materials>a priority of a smaller quantity of materials, to obtain a landing point 1, a landing point 2, a landing point 3, and a landing point 4.

FIG. 23 is an example diagram of selecting a ground landing point according to one or more aspects described herein, assuming that there are three material points. The three material points are sorted based on a priority of a larger quantity of materials>a priority of a smaller quantity of materials, to obtain a landing point 1, a landing point 2, and a landing point 3. A landing point 4 is combined with the landing point 1 (a material point with the largest quantity of materials). To be specific, a landing point 1+4, a landing point 2, and a landing point 3 are generated.

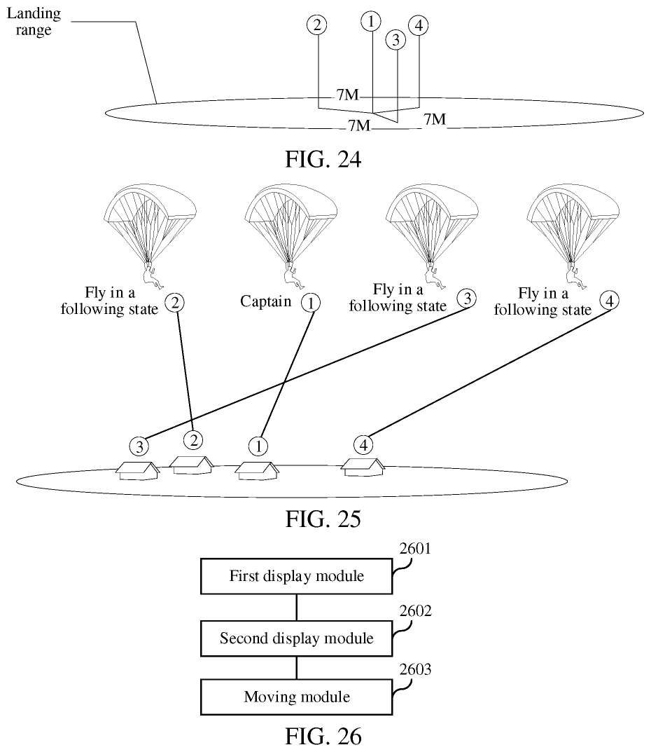

FIG. 24 is an example diagram of selecting a ground landing point according to one or more aspects described herein, assuming that there is no material point within range. A point A is a landing point 1. A landing point 2, a landing point 3, and a landing point 4 that are 7 m away from the point A are generated.

Coordinate point allocation rule: A followed object (a captain of parachuting) is defined as a teammate 1. A teammate 2, a teammate 3, and a teammate 4 are defined according to a following sequence. A landing point 1, a landing point 2, a landing point 3, and a landing point 4 are respectively allocated to the teammates.

Landing trajectory allocation rule: FIG. 25 is an example diagram of allocating landing trajectories according to one or more aspects described herein.

Flight routes are generated in the background: teammate 1-landing point 1, teammate 2-landing point 2, teammate 3-landing point 3, and teammate 4-landing point 4. In this case, the server returns route data to player clients, and the flight routes and landing points of team parachuting are displayed on the player clients. In a flight mode of “Scattered landing”, the players descend to corresponding landing points at a constant speed based on the flight routes.

According to one or more aspects, in the battle arena game, high efficiency of searching for materials during early point occupying is required. Using the systems and processes described herein, a team can be scattered to point positions before landing at material points, so that positions of the material points are automatically allocated, to prevent team members from crowding at a same building entrance after following a captain to parachute, and prevent the same team from scrambling for materials. This greatly improves efficiency of early material searching, and improves material search experience.

The foregoing merely describes examples and is not to be construed as limiting. A person skilled in the art is to understand that various variations and modifications may be made to adapt to different application requirements.

FIG. 26 is a block diagram of an example virtual object control apparatus according to one or more aspects described herein. The virtual object control apparatus may be implemented as all or a part of a computer device by using hardware or a combination of software and hardware, to implement all or some of the operations shown in FIG. 2, FIG. 4, and FIG. 6. As shown in FIG. 26, the virtual object control apparatus includes:
a first display module 2601, configured to display at least two virtual objects in a same team;
a second display module 2602, configured to display a picture in which a follower object moves with a first virtual object, the first virtual object being one of the at least two virtual objects, and the follower object being a virtual object of the at least two virtual objects other than the first virtual object; and
a moving module 2603, configured to control a third virtual object to move toward a reference position in a virtual scene in response to that a terminal device corresponding to a second virtual object receives a reference operation, the second virtual object and the third virtual object each being one of the at least two virtual objects, and reference positions respectively corresponding to the at least two virtual objects being different (i.e., not identical, not completely the same).

In some arrangements, the reference position is in a sub-region in a first region, and sub-regions to which the reference positions respectively corresponding to the at least two virtual objects belong are different. The first region is a region corresponding to a position of the second virtual object.

In some examples, the sub-regions to which the reference positions respectively corresponding to the at least two virtual objects belong are at least two sub-regions, among sub-regions of the first region, that are ranked in front in descending order of region priorities.

In some aspects, the region priority of the sub-region is associated with at least one of the following information:
a quantity of virtual resources included in the sub-region;
a type of a virtual resource included in the sub-region; and
a region type of the sub-region.

In some arrangements, a position, in a region queue, of the sub-region to which the reference position corresponding to the third virtual object belongs is associated with a number of the third virtual object in the team.

The region queue is a queue of at least two sub-regions arranged in descending order of region priorities.

In some examples, the sub-regions to which the reference positions respectively corresponding to the at least two virtual objects belong are at least two sub-regions, among sub-regions of the first region, that are specified by the reference operation.

In some arrangements, the second display module 2602 is further configured to display a number of the third virtual object in the team and indication information based on the reference position corresponding to the third virtual object. The indication information is configured for indicating at least one of the following: a range of a sub-region including the reference position corresponding to the third virtual object, and a distance between the third virtual object and the reference position corresponding to the third virtual object.

In some examples, the second display module 2602 is further configured to display a prompt element. The prompt element is configured for indicating a path of the third virtual object moving toward the reference position.

In some arrangements, the second display module 2602 is further configured to display a number of a fourth virtual object in the team based on a reference position corresponding to the fourth virtual object. The fourth virtual object is a virtual object in the team other than the third virtual object.

According to some aspects, in response to that the second virtual object and the third virtual object are a same virtual object, the moving module 2603 is configured to: display a scatter control; and control the third virtual object to move toward a reference position in the virtual scene in response to receiving a reference operation performed based on the scatter control.

In some examples, the moving module 2603 is configured to:
in response to receiving a trigger operation on the scatter control, display select controls corresponding to sub-regions in a first region, the first region being a region corresponding to a position of the third virtual object;
in response to receiving a trigger operation on a select control corresponding to a first sub-region, set a position in the first sub-region as a reference position corresponding to a candidate virtual object in the team, the candidate virtual object being a virtual object, in the team, for which no reference position is set; and
when reference positions are set for the at least two virtual objects, control the third virtual object to move toward the reference position corresponding to the third virtual object.

According to various aspects, the candidate virtual object is a virtual object, in the team, for which no reference position is set and that has a smallest number in the team.

In some arrangements, the apparatus further includes:
a cancellation module, configured to cancel the select control corresponding to the first sub-region after the position in the first sub-region is set as the reference position corresponding to the candidate virtual object in the team.

In some examples, when no virtual resource exists in the first region, reference positions corresponding to virtual objects in the team other than the second virtual object are distributed around a reference position corresponding to the second virtual object, and distances between the reference positions of the other virtual objects and the reference position of the second virtual object are reference distances.

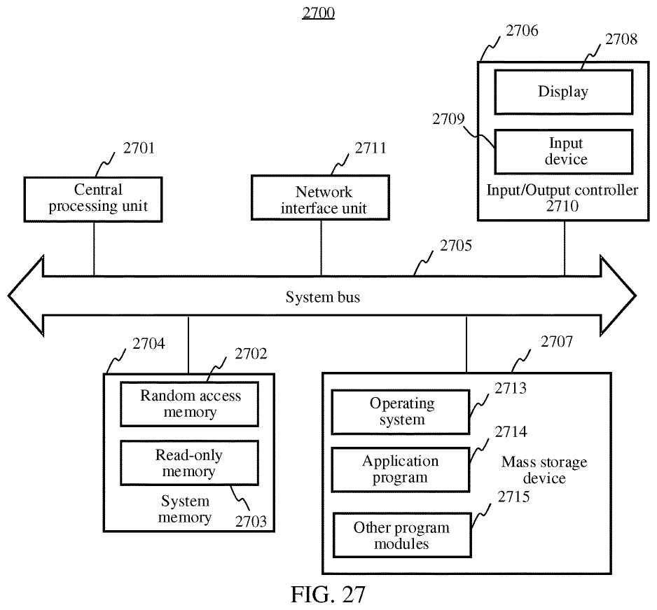

FIG. 27 is a diagram of a structure of an example computer device according to one or more aspects described herein. The computer device 2700 includes a central processing unit (CPU) 2701, a system memory 2704 including a random access memory (RAM) 2702 and a read-only memory (ROM) 2703, and a system bus 2705 connecting the system memory 2704 and the CPU 2701. The computer device 2700 further includes a basic input/output (I/O) system 2706 that facilitates information transmission between components in a computer, and a mass storage device 2707 configured to store an operating system 2713, an application program 2714, and other program modules 2715.

The basic I/O system 2706 includes a display 2708 configured to display information, and an input device 2709, such as a mouse or a keyboard, configured for a user to input information. The display 2708 and the input device 2709 are both connected to the CPU 2701 through an I/O controller 2710 connected to the system bus 2705. The basic I/O system 2706 may further include the I/O controller 2710 to be configured to receive and process inputs from a plurality of other devices such as a keyboard, a mouse, and an electronic stylus. Similarly, the I/O controller 2710 further provides an output to a display, a printer, or other types of output devices.

The mass storage device 2707 is connected to the CPU 2701 through a mass storage controller (not shown) connected to the system bus 2705. The mass storage device 2707 and an associated computer-readable medium provide nonvolatile storage for the computer device 2700. In other words, the mass storage device 2707 may include a computer-readable medium (not shown) such as a hard disk or a compact disc ROM (CD-ROM) drive.

Without loss of generality, the computer-readable medium may include a computer storage medium and a communication medium. The computer storage medium includes volatile and nonvolatile media, and removable and non-removable media implemented by any method or technology configured for storing information such as computer-readable instructions, data structures, program modules, or other data. The computer storage medium includes a RAM, a ROM, an erasable programmable ROM (EPROM), an electrically erasable programmable ROM (EEPROM), a flash memory or another solid-state memory, a CD-ROM, a digital video disc (DVD) or another optical memory, a tape cartridge, a magnetic tape, a magnetic disk memory, or another magnetic storage device. Certainly, a person skilled in the art may know that the computer storage medium is not limited to the foregoing several types. The system memory 2704 and the mass storage device 2707 may be collectively referred to as a memory.

The computer device 2700 may be connected to the Internet or another network device through a network interface unit 2711 connected to the system bus 2705.

The memory further includes one or more programs. The one or more programs are stored in the memory. The CPU 2701 executes the one or more programs to implement all or some of the operations of the methods shown in FIG. 2, FIG. 4, and FIG. 6.

In some examples, a chip is further provided. The chip includes a programmable logic circuit and/or program instructions. When the chip is run on a computer device, the chip is configured to implement all or some of the operations of the methods described herein.

In various arrangements, a computer program product or a computer program is further provided. The computer program product or the computer program includes computer instructions. The computer instructions are stored in a nonvolatile computer-readable storage medium. A processor of a computer device reads the computer instructions from the nonvolatile computer-readable storage medium. The processor executes the computer instructions, to enable the computer device to implement all or some of the operations of the methods described herein.

In some arrangements, a nonvolatile computer-readable storage medium is further provided. The nonvolatile computer-readable storage medium has a computer program stored therein. The computer program is loaded and executed by a processor, to enable a computer to implement all or some of the operations of the methods described herein.

A person of ordinary skill in the art may understand that all or some of the operations described herein may be implemented by hardware, or may be implemented by a program instructing related hardware. The program may be stored in a nonvolatile computer-readable storage medium. The storage medium may be a ROM, a magnetic disk, an optical disc, or the like.

A person skilled in the art is to be aware that, in the foregoing one or more examples, the functions described herein may be implemented by hardware, software, firmware, or any combination thereof. When the functions are implemented by software, the functions may be stored in a computer-readable medium or transmitted as one or more instructions or code in the computer-readable medium. The computer-readable medium includes a computer storage medium and a communication medium. The communication medium includes any medium that enables a computer program to be transmitted from one place to another. The storage medium may be any available medium accessible to a general-purpose or dedicated computer.

“A plurality of” or “at least two” mentioned in this specification means two or more. “And/or” describes an association relationship between associated objects and indicates that three relationships may exist. For example, A and/or B may indicate the following three cases: Only A exists, both A and B exist, and only B exists. The character “/” usually indicates an “or” relationship between the associated objects.

The foregoing descriptions are merely example aspects, and are not intended to limit this application. Any modification, equivalent replacement, or improvement made within the principle of this application shall fall within the protection scope of this application.

What is claimed is:

1. A virtual object control method, the method being performed by a computer device, and the method comprising:
generating a first electronic display of at least two virtual objects in a same team of an electronic video game;
generating a second electronic display in which a follower object moves with a first virtual object within the electronic video game, the first virtual object being one of the at least two virtual objects, and the follower object being another virtual object of the at least two virtual objects other than the first virtual object;
determining that a terminal device corresponding to a second virtual object received a reference operation; and
in response to determining that the terminal device corresponding to the second virtual object received the reference operation, controlling a third virtual object to move toward a reference position in a virtual scene, the second virtual object and the third virtual object each being one of the at least two virtual objects in the electronic video game, and reference positions respectively corresponding to the at least two virtual objects being different from one another.

2. The method according to claim 1, wherein the reference position for the third virtual object is in a sub-region in a first region, and sub-regions to which the reference positions respectively corresponding to the at least two virtual objects belong are different; and
the first region is a region corresponding to a position of the second virtual object.

3. The method according to claim 2, wherein the sub-regions to which the reference positions respectively corresponding to the at least two virtual objects belong are top-ranked regions among sub-regions of the first region, the sub-regions of the first region being ranked in descending order of region priorities.

4. The method according to claim 3, wherein the region priority of a respective sub-region is associated with at least one of the following information:
a quantity of virtual resources comprised in the respective sub-region;
a type of a virtual resource comprised in the respective sub-region; and
a region type of the respective sub-region.

5. The method according to claim 3, wherein a position, in a region queue, of the respective sub-region to which the reference position corresponding to the third virtual object belongs is associated with a number of the third virtual object in the team; and
the region queue is a queue of at least two sub-regions arranged in descending order of region priorities.

6. The method according to claim 2, wherein the sub-regions to which the reference positions respectively corresponding to the at least two virtual objects belong are specified by the reference operation.

7. The method according to any one of claim 2, wherein the method further comprises:
displaying a number of the third virtual object in the team and indication information based on the reference position corresponding to the third virtual object,
the indication information being configured for indicating at least one of the following: a range of a sub-region comprising the reference position corresponding to the third virtual object, and a distance between the third virtual object and the reference position corresponding to the third virtual object.

8. The method according to claim 1, wherein the method further comprises:
displaying a prompt element configured for indicating a path of the third virtual object moving toward the reference position.

9. The method according to claim 1, wherein the method further comprises:
displaying a number of a fourth virtual object in the team based on a reference position corresponding to the fourth virtual object,
the fourth virtual object being a virtual object in the team other than the third virtual object.

10. The method according to claim 1, wherein, in response to determining that the second virtual object and the third virtual object are a same virtual object, the controlling a third virtual object to move toward a reference position in a virtual scene in response to determining that the terminal device corresponding to the second virtual object receives the reference operation comprises:
displaying a scatter control; and
controlling the third virtual object to move toward the reference position in the virtual scene in response to receiving the reference operation performed based on the scatter control.

11. The method according to claim 10, wherein the controlling the third virtual object to move toward the reference position in the virtual scene in response to receiving the reference operation performed based on the scatter control comprises:
in response to receiving a trigger operation on the scatter control, displaying select controls corresponding to sub-regions in a first region, the first region being a region corresponding to a position of the third virtual object;
in response to receiving a trigger operation on a select control corresponding to a first sub-region, setting a position in the first sub-region as a reference position corresponding to a candidate virtual object in the team, the candidate virtual object being a virtual object, in the team, for which no reference position is set; and
when the reference positions are set for the at least two virtual objects, controlling the third virtual object to move toward the reference position corresponding to the third virtual object.

12. The method according to claim 11, wherein the candidate virtual object is a virtual object, in the team, for which no reference position is set and that has a smallest number in the team.

13. The method according to claim 11, wherein the method further comprises:
canceling the select control corresponding to the first sub-region after the position in the first sub-region is set as the reference position corresponding to the candidate virtual object in the team.

14. The method according to claim 2, wherein when no virtual resource exists in the first region, reference positions corresponding to virtual objects in the team other than the second virtual object are distributed around a reference position corresponding to the second virtual object, and distances between the reference positions of the other virtual objects and the reference position of the second virtual object are reference distances.

15. A virtual object control apparatus comprising:
a processor; and
memory storing computer-readable instructions that, when executed, cause the virtual object control apparatus to:
generate a first electronic display of at least two virtual objects in a same team of an electronic video game;
generate a second electronic display in which a follower object moves with a first virtual object within the electronic video game, the first virtual object being one of the at least two virtual objects, and the follower object being another virtual object of the at least two virtual objects other than the first virtual object;
determine that a terminal device corresponding to a second virtual object received a reference operation; and
in response to determining that the terminal device corresponding to the second virtual object received the reference operation, control a third virtual object to move toward a reference position in a virtual scene, the second virtual object and the third virtual object each being one of the at least two virtual objects in the electronic video game, and reference positions respectively corresponding to the at least two virtual objects being different from one another.

16. The virtual object control apparatus according to claim 15, wherein the reference position for the third virtual object is in a sub-region in a first region, and sub-regions to which the reference positions respectively corresponding to the at least two virtual objects belong are different; and
the first region is a region corresponding to a position of the second virtual object.

17. The virtual object control apparatus according to claim 16, wherein the sub-regions to which the reference positions respectively corresponding to the at least two virtual objects belong are top-ranked regions among sub-regions of the first region, the sub-regions of the first region being ranked in descending order of region priorities.

18. The virtual object control apparatus according to claim 17, wherein the region priority of a respective sub-region is associated with at least one of the following information:
a quantity of virtual resources comprised in the respective sub-region;
a type of a virtual resource comprised in the respective sub-region; and
a region type of the respective sub-region.

19. A non-transitory computer-readable medium storing computer-readable instructions that, when executed, cause a virtual object control apparatus to:
generate a first electronic display of at least two virtual objects in a same team of an electronic video game;
generate a second electronic display in which a follower object moves with a first virtual object within the electronic video game, the first virtual object being one of the at least two virtual objects, and the follower object being another virtual object of the at least two virtual objects other than the first virtual object;
determine that a terminal device corresponding to a second virtual object received a reference operation; and
in response to determining that the terminal device corresponding to the second virtual object received the reference operation, control a third virtual object to move toward a reference position in a virtual scene, the second virtual object and the third virtual object each being one of the at least two virtual objects in the electronic video game, and reference positions respectively corresponding to the at least two virtual objects being different from one another.

20. The non-transitory computer-readable medium according to claim 19, wherein the reference position for the third virtual object is in a sub-region in a first region, and sub-regions to which the reference positions respectively corresponding to the at least two virtual objects belong are different; and
the first region is a region corresponding to a position of the second virtual object.
